(19) United States
(12) Patent Application Publication
(10) Pub. No.: US 2024/0157653 A1
(43) Pub. Date: May 16, 2024

(54) INFORMATION PROCESSING SYSTEM, STORAGE DEVICE, AND THREE-DIMENSIONAL SHAPING DEVICE

(71) Applicant: SEIKO EPSON CORPORATION, Tokyo (JP)

(72) Inventors: Manabu WATANABE, SHIOJIRI-SHI (JP); Hayato ASUKA, SHIOJIRI-SHI (JP)

(21) Appl. No.: 18/507,174

(22) Filed: Nov. 13, 2023

(30) Foreign Application Priority Data
Nov. 15, 2022 (JP) 2022-182341

(51) Int. Cl. B29C 64/393; B29C 64/209; B29C 64/245; B33Y 30/00; B33Y 50/02

(52) U.S. Cl. CPC B29C 64/393; B29C 64/209; B29C 64/245; B33Y 30/00; B33Y 50/02

(57) ABSTRACT

An information processing system includes information processing devices configured to control three-dimensional shaping devices configured to shape a three-dimensional shaped object, a first acquisition unit configured to acquire first shaping plate identification information for identifying a first shaping plate, the first shaping plate having an upper surface on which the three-dimensional shaped object is to be shaped and being attachable to a stage of a first three-dimensional shaping device among the three-dimensional shaping devices, a second acquisition unit configured to acquire first three-dimensional shaping device identification information for identifying the first three-dimensional shaping device, a third acquisition unit configured to acquire first-underlayer-related information related to a first underlayer to be shaped on the first shaping plate; and a control unit. The control unit stores the first shaping plate identification information, the first three-dimensional shaping device identification information, and the first-underlayer-related information in association with one another.

The present application is based on, and claims priority from JP Application Serial Number 2022-182341, filed Nov. 15, 2022, the disclosure of which is hereby incorporated by reference herein in its entirety.

### BACKGROUND

### 1. Technical Field

The present disclosure relates to an information processing system, a storage device, and a three-dimensional shaping device.

### 2. Related Art

Research and development have been conducted on a calibration of a three-dimensional shaped object obtained by laminating a shaping material at least a part of which is melted.

In this regard, a three-dimensional shaping device has been known. The three-dimensional shaping device includes: a shaping portion disposed at a position facing a placement surface on a stage; a shaping use distance detection unit configured to detect a shaping use distance L between the placement surface and a shaping reference portion on the shaping portion; and a processing execution unit configured to execute shaping processing of shaping a shaped object on the placement surface by the shaping portion using the shaping use distance L detected by the shaping use distance detection unit. The shaping use distance detection unit includes a placement surface distance detection unit integrally supported with the shaping portion and configured to detect a distance L1 to the placement surface, and a reference portion distance acquisition unit configured to acquire a distance L2 between the placement surface distance detection unit and the shaping reference portion, and detects the shaping use distance L based on a distance (L1-L2) obtained by subtracting the distance L2 acquired by the reference portion distance acquisition unit from the distance L1 detected by the placement surface distance detection unit (see JP-A-2017-217792).

Here, in the three-dimensional shaping device, a shaping plate may be attached to a stage of the three-dimensional shaping device. In this case, adhesion between the stage and a three-dimensional shaped object can be improved in the three-dimensional shaping device. However, in a case where a calibration method disclosed in JP-A-2017-217792 and the use of such a shaping plate are combined, the three-dimensional shaping device needs to perform a calibration every time the shaping plate is attached to the stage, and as a result, a cycle time in shaping of a plurality of three-dimensional shaped objects may be increased.

### SUMMARY

In order to solve the above-described problems, according to an aspect of the present disclosure, there is provided an information processing system including: one or more information processing devices configured to control one or more three-dimensional shaping devices configured to shape a three-dimensional shaped object; a first acquisition unit configured to acquire first shaping plate identification information for identifying a first shaping plate, the first shaping plate having an upper surface on which the three-dimensional shaped object is to be shaped and being attachable to a stage of a first three-dimensional shaping device among the one or more three-dimensional shaping devices; a second acquisition unit configured to acquire first three-dimensional shaping device identification information for identifying the first three-dimensional shaping device; a third acquisition unit configured to acquire first-underlayer-related information related to a first underlayer to be shaped on the upper surface of the first shaping plate; and a control unit. The control unit stores, in a storage device, the first shaping plate identification information, the first three-dimensional shaping device identification information, and the first-underlayer-related information in association with one another.

According to another aspect of the present disclosure, there is provided an information processing system including: one or more information processing devices configured to control one or more three-dimensional shaping devices configured to shape a three-dimensional shaped object; a first acquisition unit configured to acquire first shaping plate identification information for identifying a first shaping plate, the first shaping plate having an upper surface on which the three-dimensional shaped object is to be shaped and being attachable to a stage of a first three-dimensional shaping device among the one or more three-dimensional shaping devices; a second acquisition unit configured to acquire first three-dimensional shaping device identification information for identifying the first three-dimensional shaping device; and a control unit. The control unit acquires, from a storage device that stores the first shaping plate identification information and first-underlayer-related information related to a first underlayer to be shaped on the upper surface of the first shaping plate in association with each other, the first-underlayer-related information associated with the first shaping plate identification information acquired by the first acquisition unit, and determines whether to perform a calibration for each of a height of a nozzle from which the first three-dimensional shaping device discharges a shaping material and a height of the stage of the first three-dimensional shaping device, based on the acquired first-underlayer-related information and the first three-dimensional shaping device identification information acquired by the second acquisition unit.

According to another aspect of the present disclosure, there is provided a storage device provided in an information processing system including one or more information processing devices that control one or more three-dimensional shaping devices configured to shape a three-dimensional shaped object. The storage device stores first shaping plate identification information for identifying a first shaping plate and first-underlayer-related information in associated with each other, the first shaping plate having an upper surface on which the three-dimensional shaped object is to be shaped and being attachable to a stage of a first three-dimensional shaping device among the one or more three-dimensional shaping devices, and the first-underlayer-related information being related to a first underlayer to be shaped on the upper surface of the first shaping plate. The first-underlayer-related information includes three-dimensional shaping device identification information for identifying the three-dimensional shaping device that has shaped the first underlayer among the one or more three-dimensional shaping devices.

According to another aspect of the present disclosure, there is provided a three-dimensional shaping device including: a stage; a discharge head configured to discharge a shaping material on a shaping plate attached to the stage; a detection unit configured to detect shaping plate identification information of the shaping plate when the shaping plate is attached to the stage; a moving part configured to move the stage and the discharge head relative to each other; and a control unit. The shaping plate identification information is information for identifying the shaping plate. The control unit acquires, from a storage device that stores the shaping plate identification information and underlayer-related information related to an underlayer to be shaped on an upper surface of the first shaping plate in association with each other, the underlayer-related information associated with the shaping plate identification information detected by the detection unit, and determines whether to perform a calibration for each of a height of a nozzle of the discharge head and a height of the stage, based on the acquired underlayer-related information.

According to another aspect of the present disclosure, there is provided an information processing system including: one or more information processing devices configured to control one or more three-dimensional shaping devices configured to shape a three-dimensional shaped object. The information processing system determines, according to a use history of a first shaping plate, whether to perform a calibration for each of a height of a nozzle from which a first three-dimensional shaping device discharges a shaping material and a height of a stage of the first three-dimensional shaping device, the first shaping plate having an upper surface on which the three-dimensional shaped object is to be shaped and being attachable to the stage of the first three-dimensional shaping device among the one or more three-dimensional shaping devices.

### BRIEF DESCRIPTION OF THE DRAWINGS

FIG. 1 is a diagram illustrating an example of a configuration of an information processing system.

FIG. 2 is a diagram illustrating an example of a hardware configuration of an information processing device.

FIG. 3 is a diagram illustrating an example of a functional configuration of the information processing device.

FIG. 4 is a flowchart illustrating an example of a flow of calibration determination processing performed by the information processing device.

FIG. 5 is a table exemplifying a plurality of records associated with shaping plate identification information for identifying a certain shaping plate among records included in shaping plate use history information in a table format.

FIG. 6 is a flowchart illustrating an example of a flow of processing in which a first information processing device causes a first three-dimensional shaping device to shape a first underlayer on a first shaping plate.

FIG. 7 is a diagram illustrating an example of a relative positional relationship between a nozzle of the first three-dimensional shaping device and a stage of the first three-dimensional shaping device when viewed along a direction orthogonal to a gravity direction at a timing before start of calibration initialization.

FIG. 8 is a diagram illustrating an example of a relative positional relationship between the nozzle of the first three-dimensional shaping device and the stage of the first three-dimensional shaping device immediately after execution of calibration initialization.

FIG. 9 is a diagram illustrating an example of a relative positional relationship between the nozzle of the first three-dimensional shaping device and the stage of the first three-dimensional shaping device immediately after execution of a nozzle calibration.

FIG. 10 is a diagram illustrating an example of a relative positional relationship between the nozzle of the first three-dimensional shaping device and the stage of the first three-dimensional shaping device immediately after execution of a stage calibration.

### DESCRIPTION OF EMBODIMENTS

### Embodiments

Hereinafter, embodiments of the present disclosure will be described with reference to the drawings.

### Overview of Information Processing System

First, an overview of an information processing system according to an embodiment will be described.

The information processing system according to the embodiment includes one or more information processing devices that control one or more three-dimensional shaping devices configured to shape a three-dimensional shaped object. The information processing system includes a first acquisition unit, a second acquisition unit, a third acquisition unit, and a control unit. The first acquisition unit acquires first shaping plate identification information for identifying a first shaping plate. The first shaping plate is a shaping plate having an upper surface on which the three-dimensional shaped object is to be shaped, and is attachable to a stage of a first three-dimensional shaping device among the one or more three-dimensional shaping devices. The second acquisition unit acquires first three-dimensional shaping device identification information for identifying the first three-dimensional shaping device. The third acquisition unit acquires first-underlayer-related information related to a first underlayer to be shaped on the upper surface of the first shaping plate. The control unit causes a storage device to store the first shaping plate identification information, the first three-dimensional shaping device identification information, and the first-underlayer-related information in association with one another.

Accordingly, the information processing system can determine whether to perform a calibration for each of a height of a nozzle from which the first three-dimensional shaping device discharges a shaping material and a height of the stage of the first three-dimensional shaping device, based on information in which the first shaping plate identification information, the first three-dimensional shaping device identification information, and the first-underlayer-related information are associated with each other. As a result, in the information processing system, it is possible to prevent an increase in cycle time in shaping of a plurality of three-dimensional shaped objects using the shaping plate.

Hereinafter, a configuration of the information processing system according to the embodiment and processing performed by the information processing system will be described in detail.

### Configuration of Information Processing System

Hereinafter, the configuration of the information processing system according to the embodiment will be described by taking an information processing system 1 as an example.

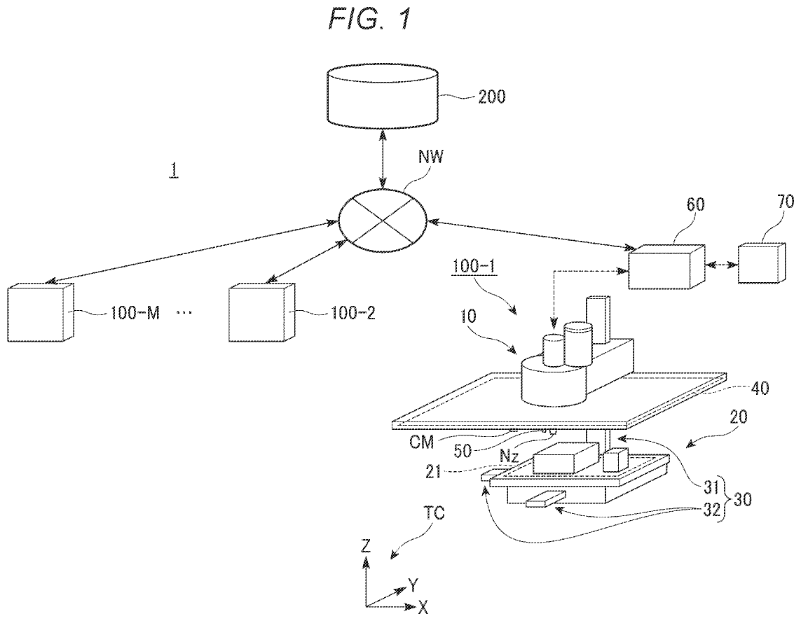

FIG. 1 is a diagram illustrating an example of a configuration of the information processing system 1.

Here, a three-dimensional coordinate system TC is a three-dimensional orthogonal coordinate system indicating directions in a drawing in which the three-dimensional coordinate system TC is drawn. Hereinafter, for convenience of description, an X axis in the three-dimensional coordinate system TC will be simply referred to as an X axis. Hereinafter, for convenience of description, a Y axis in the three-dimensional coordinate system TC is simply referred to as a Y axis. Hereinafter, for convenience of description, a Z axis in the three-dimensional coordinate system TC is simply referred to as a Z axis. Hereinafter, for example, a case where a negative direction of the Z axis coincides with a gravity direction will be described. Therefore, hereinafter, for convenience of description, a positive direction of the Z axis is referred to as an upward direction or simply as up, and the negative direction of the Z axis is referred to as a downward direction or simply as down.

The information processing system 1 includes M three-dimensional shaping devices 100 and a storage device 200. In the example illustrated in FIG. 1, the M three-dimensional shaping devices 100 are respectively indicated by three-dimensional shaping devices 100-1 to 100-M. M may be any integer as long as M is an integer of 1 or more. Further, in FIG. 1, in order to prevent the drawing from being complicated, each of the three-dimensional shaping devices 100-2 to 100-M is illustrated as an object in a rectangular parallelepiped shape. Some or all of the M three-dimensional shaping devices 100 may have different configurations or the same configuration as long as the some or all of the M three-dimensional shaping devices 100 have functions of the first three-dimensional shaping device described below. Hereinafter, as an example, a case where the M three-dimensional shaping devices 100 have the same configuration will be described. In the information processing system 1, some or all of the M three-dimensional shaping devices 100 may be integrated with the storage device 200. Hereinafter, unless it is necessary to distinguish the M three-dimensional shaping devices 100 from one another, the M three-dimensional shaping devices 100 are collectively referred to as a three-dimensional shaping device 100.

In the information processing system 1, the three-dimensional shaping device 100 is communicably connected to the storage device 200 via a network NW. Examples of the network NW include, but are not limited to, a local area network (LAN), a wide area network (WAN), the Internet, and a mobile communication network. The network NW may include a plurality of networks different from each other. In this case, some or all of the M three-dimensional shaping devices 100 may be communicably connected to the storage device 200 via different networks.

In the information processing system 1, each of the M three-dimensional shaping devices 100 can share various types of information by storing the various types of information in the storage device 200. By sharing such information, in the information processing system 1, it is possible to prevent an increase in cycle time for shaping a plurality of three-dimensional shaped objects by the three-dimensional shaping device 100.

The three-dimensional shaping device 100 includes a discharge part 10 having a nozzle Nz, a stage 20 having a shaping surface 21 on which a three-dimensional shaped object is to be shaped, a moving part 30, a heating unit 40, a temperature detection unit 50, a detection unit CM, an information processing device 60, and a data generation device 70. In the three-dimensional shaping device 100, the information processing device 60 may be integrated with the data generation device 70. The three-dimensional shaping device 100 may not include the data generation device 70. In this case, the data generation device 70 is communicably connected to the information processing device 60 of the three-dimensional shaping device 100 from the outside. The three-dimensional shaping device 100 may not include the information processing device 60 or the data generation device 70. In this case, the information processing device 60 is communicably connected to the three-dimensional shaping device 100 from the outside. In this case, the data generation device 70 is communicably connected to the information processing device 60 from the outside. When the three-dimensional shaping device 100 does not include the information processing device 60, the information processing system 1, instead of the M three-dimensional shaping devices 100, may include M information processing devices 60. In this case, some or all of the M information processing devices 60 may be integrated into one information processing device. In this case, some or all of the M information processing devices 60 may be integrated with the storage device 200.

The three-dimensional shaping device 100 changes a relative position between the discharge part 10 and the stage 20 while discharging a shaping material X (not shown) from the discharge part 10 toward the shaping surface 21 of the stage 20. Accordingly, the three-dimensional shaping device 100 shapes one three-dimensional shaped object having a predetermined shape by laminating N slice layers L. Here, N may be any integer as long as N is an integer of 1 or more. In this case, a first slice layer L counted from the bottom among the N slice layers L is laminated on the shaping surface 21.

In the three-dimensional shaping device 100, a shaping plate can be attached onto the shaping surface 21 of the stage 20. The shaping plate is a substantially flat plate-shaped member that can be attached onto the shaping surface 21 so as not to move relative to the stage 20, and is a member having an upper surface substantially parallel to an XY plane when attached onto the shaping surface 21. The XY plane is a virtual plane defined by the X axis and the Y axis. The shaping plate is also a member detachable from the shaping surface 21.

Here, each of one or more shaping plates attachable onto the shaping surface 21 has shaping plate identification information for identifying the shaping plate. For example, each of the one or more shaping plates has the shaping plate identification information for identifying the shaping plate, in the form of information encoded as a two-dimensional code. In this case, the detection unit CM described later detects the shaping plate identification information from the two-dimensional code in which the shaping plate identification information is encoded, and outputs the detected shaping plate identification information to the information processing device 60. Accordingly, it is possible to prevent an occurrence where the information processing device 60 acquires wrong shaping plate identification information due to a wrong operation in the acquisition of the shaping plate identification information in response to an operation of a user. Each of the one or more shaping plates may have the shaping plate identification information for identifying the shaping plate, in the form of information stored in a radio frequency identification (RFID) tag. In this case, the detection unit CM detects the shaping plate identification information from the RFID tag in which the shaping plate identification information is stored, and outputs the detected shaping plate identification information to the information processing device 60. Each of the one or more shaping plates may have the shaping plate identification information for identifying the shaping plate, in the form of information stored in an integrated circuit (IC) tag or the like. In this case, the detection unit CM detects the shaping plate identification information from the IC tag in which the shaping plate identification information is stored, and outputs the detected shaping plate identification information to the information processing device 60. Each of the one or more shaping plates may have the shaping plate identification information for identifying the shaping plate, in other forms.

When a certain shaping plate is attached onto the shaping surface 21, an underlayer having a substantially horizontal plane may be shaped on the shaping plate, as a base for shaping a three-dimensional shaped object. When the shaping plate on which the underlayer is shaped is attached onto the shaping surface 21, the three-dimensional shaping device 100 changes the relative position between the discharge part 10 and the stage 20 while discharging the shaping material X from the discharge part 10 toward the underlayer on the shaping plate. Accordingly, the three-dimensional shaping device 100 can laminate the N slice layers L on the underlayer on the shaping plate to shape the three-dimensional shaped object, and as a result, the adhesion between the stage 20 and the three-dimensional shaped object can be improved via each shaping plate and each underlayer.

A type of the shaping material X discharged to shape the underlayer is determined in advance according to a type of the shaping material X discharged to shape the three-dimensional shaped object. In the following description, for convenience of description, the shaping material X discharged to shape the underlayer is referred to as a shaping material X1, and the shaping material X discharged to shape the three-dimensional shaped object is referred to as a shaping material X2. Since the type of the shaping material X1 is determined according to the type of the shaping material X2, the user of the three-dimensional shaping device 100 needs to change the type of the shaping material X1 every time the type of the shaping material X2 changes. On the other hand, when the three-dimensional shaping device 100 laminates the underlayer on the shaping plate every time the shaping plate is attached onto the shaping surface 21, the cycle time in shaping a plurality of three-dimensional shaped objects may be increased. Therefore, for each type of the shaping material X2, the user of the three-dimensional shaping device 100 prepares a shaping plate on which an underlayer is shaped using the shaping material X1 of the type corresponding to the type of the shaping material X2. Then, when the user changes the type of the shaping material X2 to be discharged by the three-dimensional shaping device 100, the user attaches, onto the shaping surface 21, the shaping plate on which the underlayer is shaped by the shaping material X1 of the type corresponding to the type of the shaping material X2 to be discharged by the three-dimensional shaping device 100, from the plurality of shaping plates prepared for each type of the shaping material X2. In this case, the three-dimensional shaping device 100 does not need to laminate an underlayer on the shaping plate every time the type of the shaping material X2 changes. As a result, even when some or all of a plurality of three-dimensional shaped objects to be shaped by the three-dimensional shaping device 100 are three-dimensional shaped objects to be shaped by the shaping materials X2 of types different from each other, it is possible to prevent an increase in cycle time in shaping of the plurality of three-dimensional shaped objects. In the following description, for convenience of description, the shaping surface 21 and an upper surface of the underlayer shaped on the shaping plate are collectively referred to as a base surface serving as a base on which the three-dimensional shaped object is to be shaped, unless it is necessary to distinguish the shaping surface 21 from the upper surface of the underlayer shaped on the shaping plate. In the following description, for convenience of description, the user of the three-dimensional shaping device 100 is simply referred to as a user.

Each of the N slice layers L laminated on the base surface is shaped by the shaping material X discharged along a shaping path parallel to the base surface. The shaping path is a scanning path of the nozzle Nz with respect to the stage 20 that moves while discharging the shaping material X. That is, the three-dimensional shaping device 100 discharges the shaping material X by the discharge part 10 along the shaping path of an n-th slice layer L among the N slice layers L to laminate the n-th slice layer L on an (n−1)-th slice layer L. Note that n is an integer of 1 or more and N or less. Each of the N slice layers L may be formed of a single layer or a plurality of laminated layers. Here, the shaping path of a certain slice layer L includes an outline path that is a scanning path of the nozzle Nz along an outline of the slice layer L, and an infill path that is a scanning path of the nozzle Nz in a region surrounded by the outline path. That is, a certain slice layer L includes the shaping material X discharged along the outline path of the slice layer L and the shaping material X discharged along the infill path of the slice layer L. The underlayer is also shaped by laminating such a slice layer L on the shaping plate. Therefore, a description of a method of shaping the three-dimensional shaped object according to the embodiment is also a description of a method of shaping the underlayer.

The three-dimensional shaping device 100 can discharge, as the shaping material X, a material containing a thermoplastic resin from the nozzle Nz. Accordingly, the three-dimensional shaping device 100 can shape each of the three-dimensional shaped object and the underlayer shaped by the thermoplastic resin. Here, the thermoplastic resin may be, for example, a crystalline resin such as polyoxymethylene (POM), or an amorphous resin such as acrylonitrile butadiene styrene (ABS). The three-dimensional shaping device 100 can also discharge, as the shaping material X, a material containing a material other than the thermoplastic resin from the nozzle Nz.

Based on three-dimensional shaping data, the three-dimensional shaping device 100 performs shaping control of shaping such a three-dimensional shaped object. Here, the three-dimensional shaping device 100 generates the three-dimensional shaping data in response to a received operation. The three-dimensional shaping data is data for causing the three-dimensional shaping device 100 to laminate the N slice layers L to shape a three-dimensional shaped object having a predetermined shape. The three-dimensional shaping device 100 stores shape data indicating the shape. The shape data may be any type of data as long as the shape data is, for example, data indicating the shape, and is, for example, stereolithography (STL) data. Based on the received operation and the shape data, the three-dimensional shaping device 100 generates object data indicating a virtual object that includes at least a virtual shaped body having a shape indicated by the shape data one of the virtual shaped body and a virtual support body added to the shaped body to support the shaped body. The shaped body is a portion that is separated from the N slice layers L as one three-dimensional shaped object among portions of the N slice layers L to be laminated. The support body is a portion that supports the shaped body among the portions of the N slice layers L laminated. However, the support body is shaped above the underlayer. Therefore, the support body is an object different from the underlayer.

After generating the object data, the three-dimensional shaping device 100 stores the generated object data. After storing the object data, the three-dimensional shaping device 100 virtually slices the object into N slice layers VL based on slice condition information. In this way, each of the N slice layers VL obtained by virtually slicing the object by the three-dimensional shaping device 100 corresponds to the N slice layers L described above, respectively. Therefore, hereinafter, for convenience of description, an n-th slice layer VL of the N slice layers VL is referred to as a slice layer VLn, and the n-th slice layer L of the N slice layers L is referred to as a slice layer Ln. In this case, for example, a first slice layer VL1 corresponds to a first slice layer L1. Here, the slice condition information is information indicating a slice condition for virtually slicing an object into N slice layers VL, which is indicated by the object data stored in the three-dimensional shaping device 100. The slice condition information includes, as information indicating the slice condition, information such as information indicating the number of N slice layers VL and information indicating a thickness of each of the N slice layers VL. After virtually slicing the object, the three-dimensional shaping device 100 generates a slice layer VL shaping path for each of the N sliced slice layers VL based on shaping path generation condition information. As described above, a shaping path is a scanning path of the nozzle Nz with respect to the stage 20, which moves while discharging the shaping material X. Therefore, the shaping material X discharged along a shaping path of the n-th slice layer VLn is an actual slice layer Ln corresponding to the slice layer VLn.

Here, the n-th slice layer VLn is one of the slice layers obtained by slicing at least one of the shaped body and the support body included in the object. Therefore, the n-th slice layer VLn includes at least one of a portion obtained by slicing the shaped body and a portion obtained by slicing the support body. In other words, the portion obtained by slicing the shaped body among portions included in the n-th slice layer VLn is a shaped body region included in the shaped body among regions included in the n-th slice layer VLn. In addition, the portion obtained by slicing the support body among the portions included in the n-th slice layer VLn is, in other words, a support body region included in the support body among the regions included in the n-th slice layer VLn. That is, the n-th slice layer VLn includes at least one of a layer of the shaped body region and a layer of the support body region. The layer of the shaped body region is classified into two types including a first solid layer and a shaping layer. The first solid layer is a solid layer of the shaped body. The shaped body includes the first solid layer and the shaping layer laminated between the first solid layer and the first solid layer. That is, the shaped body is shaped by laminating the first solid layer and the shaping layer. In addition, the layer of the support body region is classified into three types including a second solid layer, a support layer, and a raft layer. The second solid layer is a solid layer of the support body. The raft layer is a layer serving as a base on which the first solid layer, the shaping layer, the second solid layer, and the support layer are laminated above the base surface. The support body includes the second solid layer, the support layer laminated between the second solid layer and the second solid layer, and the raft layer. That is, the support body is shaped by laminating the second solid layer, the support layer, and the raft layer. For example, when a certain shaped body has an overhang in shape, a portion of the overhang among portions of the shaped body is supported by such a support body. As described above, the type of the n-th slice layer VLn is classified according to the layer included in the n-th slice layer VLn. For example, when the n-th slice layer VLn includes only the first solid layer, the type of the n-th slice layer VLn is the first solid layer. In addition, for example, when the n-th slice layer VLn includes the first solid layer and the second solid layer, the type of the n-th slice layer VLn is represented by a combination of the type of the layer obtained by slicing the shaped body among the layers included in the n-th slice layer VLn and the type of the layer obtained by slicing the support body among the layers included in the n-th slice layer VLn, that is, a combination of the first solid layer and the second solid layer. The type of the n-th slice layer VLn is also a type of the n-th slice layer Ln. Therefore, the three-dimensional shaping device 100 can specify the type of the n-th slice layer VLn and the type of the slice layer Ln based on the slice condition information.

After generating the shaping paths of the respective N slice layers VL, the three-dimensional shaping device 100 generates three-dimensional shaping data including shaping path information indicating the generated shaping paths of the respective N slice layers VL. Here, shaping path generation condition information is information indicating a shaping path generation condition for generating the shaping path for each of the N slice layers VL. The shaping path generation condition information includes information indicating a shape of the shaping path for each type of the N slice layers VL, information indicating a width of the shaping path for each type of the N slice layers VL, information indicating a thickness of the shaping path for each type of the N slice layers VL, information indicating a movement speed of the nozzle Nz in a case where the shaping material X is discharged along the shaping path for each type of the N slice layers VL, information indicating the type of the shaping material X discharged from the nozzle Nz, and the like. The shaping path information indicating a certain shaping path includes other types of information such as information indicating a width of the shaping path, information indicating a thickness of the shaping path, and information indicating a movement speed of the nozzle Nz in a case where the shaping material X is discharged along the shaping path.

Based on the three-dimensional shaping data generated as described above, the three-dimensional shaping device 100 performs shaping control of shaping a three-dimensional shaped object. In addition, in a case of laminating the N slice layers L on the base surface in the shaping control, the three-dimensional shaping device 100 discharges the shaping material X on the base surface by the discharge part 10 to shape each of the N slice layers L, as the slice layers L of the types represented by some or all of the raft layer, the first solid layer, the shaping layer, the second solid layer, and the support layer, and laminates the N slice layers L to shape one three-dimensional shaped object.

The discharge part 10 is a discharge device configured to discharge the shaping material X onto the base surface. The discharge part 10 includes, together with the nozzle Nz described above, a material melting part configured to melt one or more types of materials to form the shaping material X, and a material supply part. Here, in the discharge part 10, the material supply part and the material melting part are coupled by a supply path. The material melting part and the nozzle Nz are coupled by a communication hole. The nozzle Nz discharges the shaping material X, which is supplied from the material melting part through the communication hole, from a tip end thereof.

In the material supply part, one or more types of materials in a state of pellets, powder, or the like are accommodated as a material to be the shaping material X. Hereinafter, as an example, a case where the material accommodated in the material supply part includes a pellet-shaped thermoplastic resin will be described. The material supply part is implemented by, for example, a hopper. The material accommodated in the material supply part is supplied to the material melting part through the supply path provided below the material supply part.

The material melting part includes a screw case, a flat screw accommodated in the screw case, a drive motor configured to drive the flat screw, and a barrel fixed below the flat screw in the screw case.

The flat screw is a screw having a flat cylindrical shape, and a spiral groove extending from an outer periphery of the cylinder toward a central axis of the cylinder is formed on a bottom surface of the cylinder.

The barrel is provided with a communication hole. Further, a heater is built in the barrel. A temperature of the heater is controlled by the information processing device 60.

The material serving as the shaping material X is supplied from the material supply part to between the rotating flat screw and the barrel via the supply path. The material supplied to between the rotating flat screw and the barrel is at least partially melted by the rotation of the flat screw and the heating by the heater built in the barrel, and becomes the paste-like shaping material X having fluidity. The paste-like shaping material X is supplied to the nozzle Nz through the communication hole provided in the barrel by the rotation of the flat screw. The shaping material X supplied to the nozzle Nz is discharged from the tip end of the nozzle Nz toward the base surface.

The moving part 30 changes the relative position between the nozzle Nz of the discharge part 10 and the stage 20. More specifically, the moving part 30 changes the relative position between the nozzle Nz of the discharge part 10 and the stage 20 by moving one or both of the discharge part 10 and the stage 20. Hereinafter, as an example, a case in which the relative position between the nozzle Nz of the discharge part 10 and the stage 20 is changed by the moving part 30 moving the stage 20 will be described. For example, the moving part 30 includes a first moving mechanism 31 configured to move the discharge part 10 along the Z axis, and a second moving mechanism 32 configured to move the stage 20 along the X axis and the Y axis with respect to the discharge part 10. In the embodiment, the first moving mechanism 31 illustrated in FIG. 1 is implemented by an elevating device configured to move the discharge part 10 along the Z axis, and includes a motor for moving the discharge part 10 along the Z axis. The second moving mechanism 32 illustrated in FIG. 1 is implemented by a horizontal conveyance device configured to move the stage 20 along the X axis and the Y axis, and includes a motor for moving the stage 20 along the X axis and a motor for moving the stage 20 along the Y axis. The first moving mechanism 31 and the second moving mechanism 32 are controlled by the information processing device 60. The moving part 30 may change a relative position between the temperature detection unit 50 described later and the stage 20 in addition to changing the relative position between the nozzle Nz of the discharge part 10 and the stage 20. In this case, the moving part 30 may not change a relative position between the nozzle Nz of the discharge part 10 and the temperature detection unit 50, or may change the relative position between the nozzle Nz of the discharge part 10 and the temperature detection unit 50. In the example illustrated in FIG. 1, the temperature detection unit 50 is provided at the discharge part 10. Therefore, in this example, the moving part 30 changes the relative position between the temperature detection unit 50 described later and the stage 20 in addition to changing the relative position between the nozzle Nz of the discharge part 10 and the stage 20. In this example, the moving part 30 does not change the relative position between the nozzle Nz of the discharge part 10 and the temperature detection unit 50.

The heating unit 40 heats a shaping region including the shaping material X discharged from the discharge part 10. Here, the shaping region is a region where the three-dimensional shaping device 100 shapes the three-dimensional shaped object and the underlayer. More specifically, the shaping region is a region including all the N slice layers L in the case where the N slice layers L are laminated on the base surface as one three-dimensional shaped object or an underlayer, among a region including the base surface. The heating unit 40 may have any configuration as long as the heating unit 40 can heat the shaping region. In the example illustrated in FIG. 1, the heating unit 40 is a flat plate-shaped panel heater that has a surface facing the base surface and that heats the shaping region. In this case, the heating unit 40 heats a region, which is sandwiched between a lower surface of the heating unit 40 having a flat plate shape and the shaping surface 21, as the shaping region. The heating unit 40 is controlled by the information processing device 60. In the example illustrated in FIG. 1, the heating unit 40 is provided with a through hole through which the nozzle Nz is inserted. Therefore, the heating unit 40 is provided around the nozzle Nz and moves together with the nozzle Nz. The heating unit 40 may be a heater of a chamber type for feeding warm air, a cartridge heater, or any other type of heater capable of heating an inside of the shaping region, instead of the panel heater. The three-dimensional shaping device 100 may not include the heating unit 40.

The temperature detection unit 50 is a temperature sensor configured to detect a temperature of an upper surface of the slice layer L laminated on the base surface. In the example illustrated in FIG. 1, the temperature detection unit 50 is provided at the lower surface of the heating unit 40. The temperature detection unit 50 outputs information indicating the detected temperature to the information processing device 60. The three-dimensional shaping device 100 may not include the temperature detection unit 50.

When the shaping plate is attached onto the shaping surface 21 of the stage 20, the detection unit CM detects the shaping plate identification information of the shaping plate attached onto the shaping surface 21 in response to a request from the information processing device 60, and outputs the detected shaping plate identification information to the information processing device 60. In this example, the shaping plate identification information is encoded as a two-dimensional code as described above. Therefore, in this example, the detection unit CM is an imaging device, a two-dimensional code reader, or the like capable of detecting information encoded as a two-dimensional code. Alternatively, the detection unit CM may be another device capable of detecting information encoded as a two-dimensional code. In the example illustrated in FIG. 1, the detection unit CM is provided at the lower surface of the heating unit 40. The detection unit CM may be provided at another position where the shaping plate identification information can be detected from the shaping plate attached onto the shaping surface 21.

The information processing device 60 controls the entire three-dimensional shaping device 100. The information processing device 60 acquires, via a network or a recording medium, the three-dimensional shaping data generated by the data generation device 70. The information processing device 60 executes a three-dimensional shaping program stored in advance to perform the shaping control of controlling operations of the discharge part 10 and the moving part 30 according to the three-dimensional shaping data, thereby shaping a three-dimensional shaped object. The information processing device 60 may be an information processing system including a single information processing device such as a single computer, or may be an information processing system including two or more information processing devices. When the information processing device 60 is an information processing system including two or more information processing devices, the two or more information processing devices in the information processing device 60 are communicably connected to each other. The information processing device 60 may be implemented by a combination of a plurality of circuits. Hereinafter, a case where the information processing device 60 is a single information processing device will be described as an example.

The shaping control described above is control for the discharge part 10 and the moving part 30. More specifically, the shaping control is control for shaping one three-dimensional shaped object having a predetermined shape by laminating N slice layers L on the base surface. Here, the n-th slice layer Ln of the N slice layers L is laminated on the (n−1)-th slice layer Ln−1. At this time, when the n-th slice layer Ln is laminated on the (n−1)-th slice layer Ln−1, a part of the (n−1)-th slice layer Ln−1 is melted due to heat of the n-th slice layer Ln. Therefore, the n-th slice layer Ln is joined to the (n−1)-th slice layer Ln−1. As a result, on the base surface, the N slice layers L are laminated as one three-dimensional shaped object. Therefore, in the embodiment, a 0th slice layer L0 means the base surface. That is, in the embodiment, the first slice layer L1 is laminated on the 0th slice layer L0, that is, the base surface.

When laminating the n-th slice layer Ln on the (n−1)-th slice layer Ln−1 by the shaping control, the information processing device 60 controls the discharge part 10 and the moving part 30 to discharge, by the discharge part 10, the shaping material X along the shaping path of the n-th slice layer VLn corresponding to the n-th slice layer Ln. Accordingly, the information processing device 60 can laminate the n-th slice layer Ln on the (n−1)-th slice layer Ln−1. By performing the above-described control as the shaping control, the information processing device 60 discharges the shaping material X in order, and shapes one three-dimensional shaped object by laminating the N slice layers L on the base surface.

The data generation device 70 is a device configured to generate the three-dimensional shaping data used by the three-dimensional shaping device 100 to shape a three-dimensional shaped object. The data generation device 70 generates the three-dimensional shaping data by the above-described method in which the three-dimensional shaping device 100 generates the three-dimensional shaping data. Therefore, the description of the method is omitted here. The data generation device 70 stores the shape data in response to a received operation. The data generation device 70 may be capable of generating the shape data or may not be capable of generating the shape data. When the data generation device 70 is not capable of generating the shape data, the data generation device 70 acquires the shape data from another device via a network or a storage medium. The data generation device 70 stores the slice condition information, the shaping path generation condition information, and the like in response to a received operation.

The data generation device 70 is, for example, an information processing device such as a workstation, a desktop personal computer (PC), a notebook PC, a tablet PC, a multifunctional mobile phone terminal (smartphone), a mobile phone terminal, or a personal digital assistant (PDA), and is not limited thereto. More specifically, the data generation device 70 is implemented by a computer including one or more processors, a memory, and an input and output interface through which signals are input and output from and to an outside.

The storage device 200 may be any information processing device as long as the storage device 200 is an information processing device capable of functioning as a server, and is, for example, an information processing device such as a workstation, a desktop personal computer (PC), or a notebook PC, and is not limited thereto. More specifically, the storage device 200 is implemented by a computer including one or more processors, a memory, and an input and output interface through which signals are input and output from and to the outside. The storage device 200 stores various types of information in response to a request from the information processing device 60. The storage device 200 outputs various types of information in response to a request from the information processing device 60. The storage device 200 may be integrated with some or all of storage units 62 of the M information processing devices 60.

### Hardware Configuration of Control Device

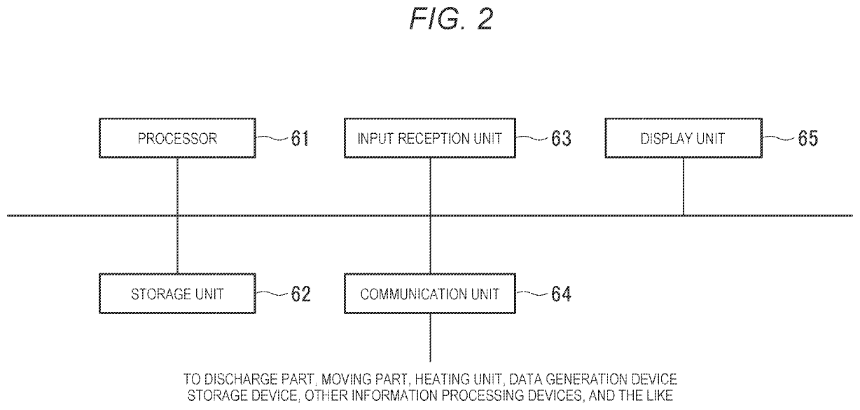

Hereinafter, a hardware configuration of the information processing device 60 will be described with reference to FIG. 2. FIG. 2 is a diagram illustrating an example of the hardware configuration of the information processing device 60.

The information processing device 60 includes a processor 61, the storage unit 62, an input reception unit 63, a communication unit 64, and a display unit 65. As described above, the information processing device 60 may be configured separately from the three-dimensional shaping device 100. In this case, the three-dimensional shaping device 100 is communicably connected to the information processing device 60 and is controlled by the information processing device 60.

The processor 61 is, for example, a central processing unit (CPU). The processor 61 may be another processor such as a field programmable gate array (FPGA). The processor 61 may include a plurality of processors. The processor 61 implements various functions of the information processing device 60 by executing various programs, various commands, and the like stored in the storage unit 62.

The storage unit 62 is a storage device including a hard disk drive (HDD), a solid state drive (SSD), an electrically erasable programmable read only memory (EEPROM), a read only memory (ROM), a random access memory (RAM), and the like. The storage unit 62 may be an external storage device coupled by a digital input and output port such as a universal serial bus (USB) instead of being built in the information processing device 60. The storage unit 62 stores various programs, various commands, various types of information, and the like to be processed by the information processing device 60. For example, the storage unit 62 stores the three-dimensional shaping data.

The input reception unit 63 receives an operation performed by the user while viewing an image displayed on the display unit 65. The input reception unit 63 is, for example, an input device including a keyboard, a mouse, a touch pad, and the like. The input reception unit 63 may be a touch panel integrated with the display unit 65.

The communication unit 64 includes, for example, a digital input and output port such as a USB and an Ethernet (registered trademark) port.

The display unit 65 displays an image. As a display provided in the information processing device 60, the display unit 65 is, for example, a display device including a liquid crystal display panel, an organic electroluminescence (EL) display panel or the like.

### Functional Configuration of Control Device

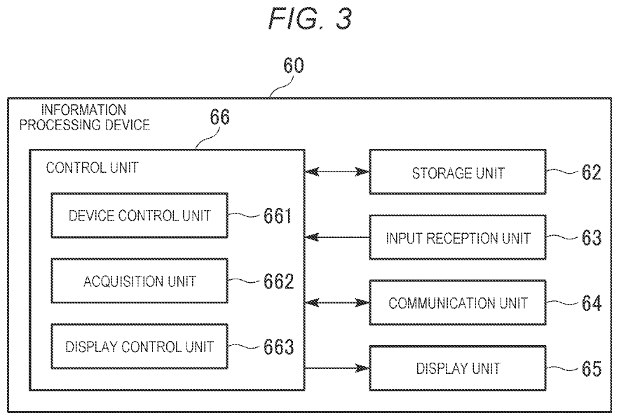

Hereinafter, a functional configuration of the information processing device 60 will be described with reference to FIG. 3. FIG. 3 is a diagram illustrating an example of the functional configuration of the information processing device 60.

The information processing device 60 includes the storage unit 62, the input reception unit 63, the communication unit 64, the display unit 65, and a control unit 66.

The control unit 66 controls the entire information processing device 60. The control unit 66 includes a device control unit 661, an acquisition unit 662, and a display control unit 663. These functional units of the control unit 66 are implemented by, for example, the processor 61 executing various programs stored in the storage unit 62. Some or all of the functional units may be hardware functional units such as large scale integration (LSI) and an application specific integrated circuit (ASIC).

The device control unit 661 controls the entire three-dimensional shaping device 100. For example, the device control unit 661 controls each of the discharge part 10, the moving part 30, and the heating unit 40.

The acquisition unit 662 acquires various types of information from the storage unit 62, the storage device 200, other devices, and the like in response to a received operation. A plurality of the acquisition units 662 may be configured as separate functional units for each piece of information to be acquired.

The display control unit 663 generates various images. The display control unit 663 displays the generated image on the display unit 65. When the information processing device 60 includes a speaker, the display control unit 663 may be configured as an output control unit that causes the display unit 65 to display an image and causes the speaker to output a sound. In this case, the display unit 65 may be configured as an output unit including the speaker and the display unit 65. Here, the output unit may be configured to include another functional unit capable of outputting information in place of some or all of the display unit 65 and the speaker, or in addition to both of the display unit 65 and the speaker. In this case, the output control unit causes the other functional unit to output information.

### Calibration Determination Processing Performed by Control Device

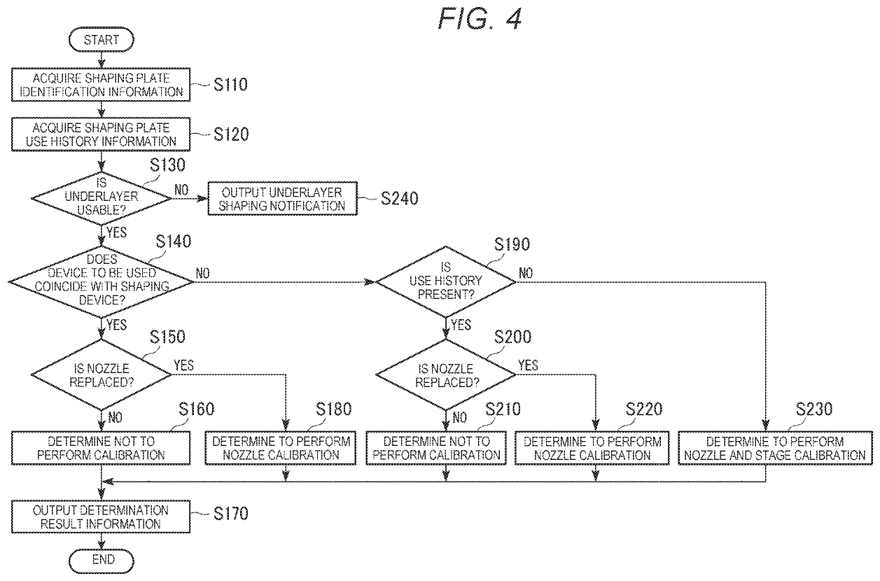

The information processing device 60 described above performs processing in the flowchart illustrated in FIG. 4 as calibration determination processing. The calibration determination processing is processing of determining, according to a use history of the shaping plate attached onto the shaping surface 21, whether to perform each of two calibrations including a nozzle calibration and a stage calibration among calibrations performed by the three-dimensional shaping device 100. The nozzle calibration is a calibration for a height of the nozzle Nz. The stage calibration is a calibration for a height of the stage 20. The nozzle calibration may include a calibration for a position of the nozzle Nz in the XY plane, or may not include the calibration. The stage calibration may include a calibration for a position of the stage 20 in the XY plane or may not include the calibration.

In the information processing system 1, the storage device 200 stores shaping plate use history information indicating a use history of each of one or more shaping plates that can be attached onto the shaping surface 21 of the stage 20 of the three-dimensional shaping device 100. That is, in the information processing system 1, the shaping plate use history information is shared between the M three-dimensional shaping devices 100. Therefore, the information processing device 60 performs the above-described calibration determination processing based on the shaping plate use history information stored in the storage device 200. Details of the shaping plate use history information will be described later.

For example, when it is determined in the calibration determination processing that the nozzle calibration and the stage calibration are not to be performed, the information processing device 60 can cause the three-dimensional shaping device 100 to start shaping the three-dimensional shaped object without the nozzle calibration or the stage calibration performed by the three-dimensional shaping device 100.

In addition, for example, when it is determined in the calibration determination processing that the stage calibration is to be performed and the nozzle calibration is not to be performed, the information processing device 60 can cause the three-dimensional shaping device 100 to perform the stage calibration without causing the three-dimensional shaping device 100 to perform the nozzle calibration, and thereafter cause the three-dimensional shaping device 100 to start shaping the three-dimensional shaped object.

For example, when it is determined in the calibration determination processing that the nozzle calibration and the stage calibration are to be performed, the information processing device 60 can cause the three-dimensional shaping device 100 to perform the nozzle calibration and the stage calibration, and thereafter cause the three-dimensional shaping device 100 to start shaping the three-dimensional shaped object.

According to the calibration determination processing described above, the information processing device 60 can prevent an increase in cycle time in shaping of a plurality of three-dimensional shaped objects using the shaping plate.

FIG. 4 is a diagram illustrating an example of a flow of the calibration determination processing performed by the information processing device 60. In FIG. 4, the flow of the calibration determination processing will be described by exemplifying the calibration determination processing performed by the information processing device 60 of the three-dimensional shaping device 100-1 among the M three-dimensional shaping devices 100. Therefore, hereinafter, for convenience of description, the three-dimensional shaping device 100-1 is referred to as a first three-dimensional shaping device, and the information processing device 60 of the first three-dimensional shaping device is referred to as a first information processing device. Hereinafter, for convenience of description, the shaping surface 21 of the first three-dimensional shaping device is referred to as a first shaping surface. Hereinafter, for convenience of description, the device control unit 661 of the first information processing device is referred to as a first device control unit. Hereinafter, for convenience of description, the acquisition unit 662 of the first information processing device is referred to as a first acquisition unit. Hereinafter, for convenience of description, the display control unit 663 of the first information processing device is referred to as a first display control unit. Hereinafter, as an example, a case is described where three-dimensional shaping device identification information for identifying the first three-dimensional shaping device is stored in the storage unit 62 of the first information processing device at a timing before the processing of step S110 illustrated in FIG. 4 is performed. In addition, hereinafter, a case will be described where a first shaping plate is attached onto the first shaping surface at the timing, and thereafter, the first information processing device receives a determination processing start operation of starting the calibration determination processing.

After receiving the determination processing start operation, the detection unit CM of the first three-dimensional shaping device detects shaping plate identification information of the shaping plate attached onto the first shaping surface, and outputs the detected shaping plate identification information to the first information processing device. Accordingly, in this case, the first acquisition unit acquires, from the detection unit CM, the shaping plate identification information for identifying the shaping plate attached to the first shaping surface (step S110). Hereinafter, for convenience of description, the shaping plate identified according to the shaping plate identification information acquired by the first acquisition unit in step S110 is referred to as the first shaping plate. In the calibration determination processing, the processing of step S110 may be omitted. In this case, the shaping plate identification information for identifying the first shaping plate is, for example, acquired by the first acquisition unit in response to an operation received in advance and is stored in the storage unit 62. In this case, the first information processing device can start the calibration determination processing even when the first shaping plate is not attached onto the first shaping surface.

Next, the first acquisition unit acquires the shaping plate use history information stored in advance in the storage device 200 from the storage device 200 via the network NW (step S120). Here, the shaping plate use history information will be described.

The shaping plate use history information is information indicating a use history of each of one or more shaping plates that can be attached onto the shaping surface 21 of the three-dimensional shaping device 100. The shaping plate use history information includes shaping date and time information, base material type information, job identification information, thermal history information, set value information, the three-dimensional shaping device identification information, and the like. Hereinafter, as an example, a case where the shaping plate use history information is information in a table format will be described. The shaping plate use history information may be information in other formats instead.

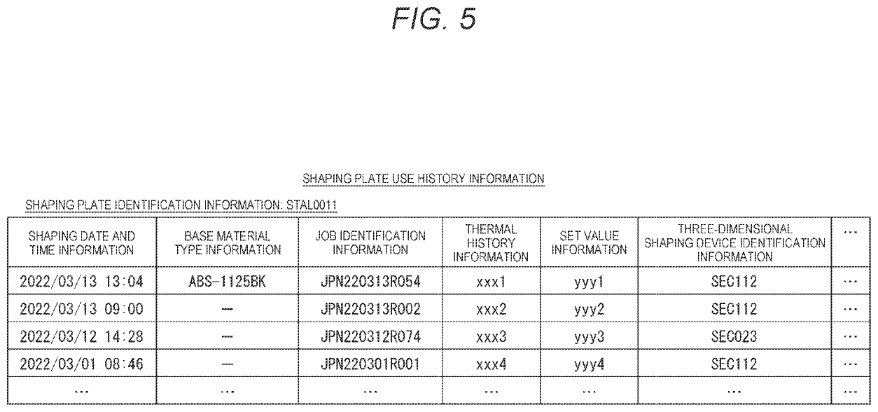

In the shaping plate use history information, one or more records associated with shaping plate identification information for identifying each of one or more shaping plates are stored. Each of one or more records associated with shaping plate identification information for identifying a certain shaping plate in the shaping plate use history information includes the shaping date and time information, the base material type information, the job identification information, the thermal history information, the set value information, the three-dimensional shaping device identification information, and the like. FIG. 5 is a table exemplifying a plurality of records associated with the shaping plate identification information for identifying a certain shaping plate among records included in the shaping plate use history information in the table format. The shaping date and time information included in a certain record among one or more records associated with the shaping plate identification information for identifying a certain shaping plate is information indicating a date and time when an object is shaped on the shaping plate. When the object is a three-dimensional shaped object, the shaping date and time information is information indicating a date and time when the three-dimensional shaped object is shaped. On the other hand, when the object is an underlayer, the shaping date and time information is information indicating a date and time when the underlayer is shaped. In this case, the first information processing device can calculate an elapsed time from the shaping of the underlayer based on a current date and time and the date and time indicated by the shaping date and time information. Therefore, the shaping date and time information is also information indicating the elapsed time. The record may include the shaping date and time information and information indicating the elapsed time. However, in this case, the information is constantly updated by the information processing device 60 as the time elapses. The information indicating the elapsed time can be used for maintenance of the underlayer corresponding to the elapsed time. The base material type information included in the record is information indicating the type of the shaping material X1 constituting an underlayer when the object shaped at the date and time indicated by the shaping date and time information included in the record is an underlayer, and is also information indicating whether the object is an underlayer. For example, when the base material type information is null information, the base material type information indicates that the object is not an underlayer but a three-dimensional shaped object. In FIG. 5, the null information is shown by “-”. The job identification information included in the record is information for identifying a job of causing the three-dimensional shaping device 100 to shape the object. The thermal history information included in the record is information indicating a thermal history of the shaping plate, and is also information indicating a thermal history of an underlayer shaped on the shaping plate when the underlayer is shaped on the shaping plate. The thermal history information includes thermal history integrated value information indicating an integrated value of the thermal history of the shaping plate. Details of the integrated value of the thermal history will be described later. In the example illustrated in FIG. 5, in order to prevent the drawing from becoming complicated, the thermal history information is shown by “xxx1” to “xxx4”. The thermal history information may include information indicating a heating time over which the shaping plate is heated. The information is also information indicating a heating time over which an underlayer is heated when the underlayer is shaped on the shaping plate. For example, the first information processing device can calculate the heating time as an operating time of the heating unit 40. The information indicating the heating time can be used for maintenance of the underlayer corresponding to the heating time. The thermal history information may include information indicating a heating temperature at which the shaping plate is heated. The information is also information indicating a heating temperature at which an underlayer is heated when the underlayer is shaped on the shaping plate. For example, the first information processing device can specify the heating temperature as a temperature set in the heating unit 40. For example, the first information processing device may specify the heating temperature by a sensor detecting a temperature in the shaping region. The information indicating the heating temperature can be used for maintenance of the underlayer corresponding to the heating temperature. The set value information included in the record is information indicating various types of set values set in the three-dimensional shaping device 100 that shapes the object. The various types of set values are, for example, set temperatures set in the heating unit 40, but are not limited thereto. In this example, in order to prevent the drawing from becoming complicated, the set value information is shown by “yyy1” to “yyy4”. The three-dimensional shaping device identification information included in the record is three-dimensional shaping device identification information of the three-dimensional shaping device 100 that performs the shaping. For example, when the underlayer shaped on the shaping plate is removed from the shaping plate, the first information processing device deletes, from a storage area of the storage device 200, the record associated with the shaping plate identification information for identifying the shaping plate among the records included in the shaping plate use history information. Accordingly, in the information processing system 1, the capacity of the storage area of the storage device 200 can be prevented from becoming insufficient. Accordingly, the first information processing device can set the maximum number of records including the base material type information among the records associated with the shaping plate identification information for identifying the shaping plate to 1. In this case, the first information processing device can calculate the number of uses of the underlayer shaped on the shaping plate at the current date and time by counting the number of records, from a record including the base material type information to a most recently generated record, in the records associated with the shaping plate identification information for identifying the shaping plate. Therefore, the record associated with the shaping plate identification information for identifying the shaping plate is also information indicating the number of uses. Each record associated with the shaping plate identification information for identifying the shaping plate may include the information indicating the number of uses. As described above, the shaping plate use history information is also underlayer-related information related to the underlayer shaped on the shaping plate. The information indicating the number of uses can be used for maintenance of the underlayer corresponding the number of uses.

In step S120, the first information processing device may read, from the storage unit 62, information related to a first underlayer from the shaping plate use history information as illustrated in FIG. 5 as the underlayer-related information. Each time the first three-dimensional shaping device to which the first shaping plate is attached shapes an object, the first information processing device transmits information including the shaping date and time information, the base material type information, the job identification information, the thermal history information, the set value information, the three-dimensional shaping device identification information, and the like to the storage device 200, and adds a record including the transmitted information to the shaping plate use history information. When such processing is performed by each of the M three-dimensional shaping devices 100, the shaping plate use history information shared between the M three-dimensional shaping devices 100 is stored in the storage device 200. Hereinafter, for convenience of description, the underlayer shaped on the first shaping plate is referred to as a first underlayer.

After the processing of step S120 is performed, the first device control unit extracts, as first shaping plate use history information, one or more records associated with the shaping plate identification information acquired by the acquisition unit 662 in step S110, from the shaping plate use history information acquired by the acquisition unit 662 from the storage device 200 in step S120. Thereafter, the first device control unit determines, based on the extracted first shaping plate use history information, whether the first underlayer is usable (step S130). Here, the processing of step S130 will be described. The acquisition unit 662 may acquire the first shaping plate use history information in step S120.

In step S130, for example, when the first shaping plate use history information satisfies a predetermined determination condition, the first device control unit determines that the first underlayer is usable. On the other hand, in step S130, for example, when the first shaping plate use history information does not satisfy the determination condition, the first device control unit determines that the first underlayer is unusable. Here, the determination condition includes each of the following conditions 1 to 4.

(Condition 1): The first underlayer is not shaped on the first shaping plate.

(Condition 2): The number of uses of the first underlayer exceeds a predetermined first threshold.

(Condition 3): An elapsed time from the shaping of the first underlayer exceeds a predetermined second threshold.

(Condition 4): An integrated value of a thermal history of the first underlayer exceeds a predetermined third threshold.

When the first shaping plate use history information satisfies at least one of the conditions 1 to 4, the first device control unit determines that the first shaping plate use history information satisfies the determination condition. On the other hand, when the first shaping plate use history information satisfies none of the conditions 1 to 4, the first device control unit determines that the first shaping plate use history information does not satisfy the determination condition.

Specifically, the first device control unit determines whether a record including the base material type information that is not null information is included in the first shaping plate use history information. When it is determined that the record is not included in the first shaping plate use history information, the first device control unit determines that the first shaping plate use history information satisfies the condition 1. This is because, when the record is not included in the first shaping plate use history information, it means that the first underlayer is not shaped on the first shaping plate, that is, the first underlayer is unusable. On the other hand, when it is determined that the record is included in the first shaping plate use history information, the first device control unit determines that the first shaping plate use history information does not satisfy the condition 1.

The first device control unit calculates the number of uses of the first underlayer based on the first shaping plate use history information. After calculating the number of uses of the first underlayer, the first device control unit determines whether the calculated number of uses of the first underlayer exceeds a first threshold. Here, the first threshold is the number of times the first underlayer can be repeatedly used without any problem in the shaping of the three-dimensional shaped object, and is a value determined based on results of preliminary experiments, simulations, and the like. When it is determined that the calculated number of uses exceeds the first threshold, the first device control unit determines that the first shaping plate use history information satisfies the condition 2. This is because, when the calculated number of uses exceeds the first threshold, it means that the first underlayer is highly likely to be unusable during use in the shaping of the three-dimensional shaped object. In the embodiment, the fact that the first underlayer is highly likely to be unusable during use is regarded as equivalent to the fact that the first underlayer is unusable. On the other hand, when it is determined that the calculated number of uses does not exceed the first threshold, the first device control unit determines that the first shaping plate use history information does not satisfy the condition 2.

The first device control unit calculates an elapsed time elapsing from the shaping of the first underlayer based on the first shaping plate use history information. After calculating the elapsed time, the device control unit 661 determines whether the calculated elapsed time exceeds a second threshold. Here, the second threshold indicates a service life of the first underlayer, and is a value determined based on results of preliminary experiments, simulations, and the like. When it is determined that the calculated elapsed time exceeds the second threshold, the first device control unit determines that the first shaping plate use history information satisfies the condition 3. This is because, when the calculated elapsed time exceeds the second threshold, it means that the first underlayer is highly likely to be unusable during use in the shaping of the three-dimensional shaped object, that is, the first underlayer is unusable. On the other hand, when it is determined that the calculated elapsed time does not exceed the second threshold, the device control unit 661 determines that the first shaping plate use history information does not satisfy the condition 3.

The first device control unit calculates the integrated value of the thermal history of the first underlayer based on the first shaping plate use history information. Here, the integrated value of the thermal history of the first underlayer is an integrated value of the heating temperature of the first underlayer for each unit time in an entire period in which the first underlayer is heated. The unit time is one minute here, and may be another usable unit time such as one second. For example, when the entire period is 60 minutes, the heating temperature of the first underlayer in the first 20 minutes of the 60 minutes is 60 [K], and the heating temperature of the first underlayer in the last 40 minutes of the 60 minutes is 80 [K], the integrated value of the thermal history of the first underlayer is 20 minutes×60 [K]+40 minutes x 80 [K]=4400 [K minutes]. Here, the unit of [K minutes] is a unit similar to [Wh] representing the amount of electric power, and is a unit used as a unit of the integrated value of the thermal history for convenience in the embodiment. As the integrated value of the thermal history of the first underlayer increases, damage to the first underlayer due to heating increases. Therefore, the integrated value of the thermal history of the first underlayer is also a value indicating damage caused to the first underlayer due to heating. The integrated value of the thermal history of the first underlayer may be a value indicating the entire period in which the first underlayer is heated, may be the highest heating temperature of the first underlayer, or may be another value based on the thermal history of the first underlayer. After calculating the integrated value, the first device control unit determines whether the calculated integrated value exceeds a third threshold. Here, the third threshold is a value corresponding to the maximum degree of damage that can be caused to the first underlayer, and is a value determined based on results of preliminary experiments, simulations, and the like. When it is determined that the calculated integrated value exceeds the third threshold, the first device control unit determines that the first shaping plate use history information satisfies the condition 4. This is because, when the calculated integrated value exceeds the third threshold, it means that the first underlayer is highly likely to be unusable during use in the shaping of the three-dimensional shaped object, that is, the first underlayer is unusable. On the other hand, when it is determined that the calculated integrated value does not exceed the third threshold, the first device control unit determines that the first shaping plate use history information does not satisfy the condition 4. The integrated value can be used for maintenance of the underlayer corresponding to the integrated value.

The determination condition may include one or more other conditions instead of some or all of the conditions 1 to 4 or in addition to all of the conditions 1 to 4.

When the first device control unit determines that the first underlayer is unusable (step S130: NO), the first display control unit causes the display unit 65 to display a notification of prompting to shape the first underlayer on the first shaping plate (step S240). Here, for example, when the first information processing device includes a speaker, the first display control unit may output a sound indicating the notification from the speaker. In this case, the first display control unit is configured as an output control unit. In FIG. 4, the processing of step S240 is indicated by “output underlayer shaping notification”. After the processing of step S240 is performed, the first device control unit may end the processing of the flowchart illustrated in FIG. 4 or may perform other processings. Therefore, in FIG. 4, a processing to which the first device control unit transitions after the processing of step S240 is performed is omitted.

On the other hand, when it is determined that the first underlayer is usable (step S130: YES), the first device control unit determines whether the first three-dimensional shaping device coincides with the three-dimensional shaping device 100 that shaped the first underlayer on the first shaping plate (step S140). In FIG. 4, the processing of step S140 is indicated by “Does device to be used coincide with shaping device?”. In step S140, for example, the first device control unit reads, from the storage unit 62 of the first information processing device, three-dimensional shaping device identification information for identifying the first three-dimensional shaping device, which is stored in advance in the storage unit 62. In addition, the device control unit 661 specifies the three-dimensional shaping device identification information included in the record including the base material type information among the records included in the first shaping plate use history information. As described above, the three-dimensional shaping device identification information is three-dimensional shaping device identification information for identifying the three-dimensional shaping device 100 that shaped the first underlayer on the first shaping plate. Therefore, when the three-dimensional shaping device identification information read from the storage unit 62 coincides with the specified three-dimensional shaping device identification information, the first device control unit determines that the first three-dimensional shaping device coincides with the three-dimensional shaping device 100 that shaped the first underlayer on the first shaping plate. On the other hand, when the three-dimensional shaping device identification information read from the storage unit 62 does not coincide with the specified three-dimensional shaping device identification information, the first device control unit determines that the first three-dimensional shaping device does not coincide with the three-dimensional shaping device 100 that shaped the first underlayer on the first shaping plate.

When it is determined that the first three-dimensional shaping device coincides with the three-dimensional shaping device 100 that shaped the first underlayer on the first shaping plate (step S140: YES), the first device control unit determines whether the nozzle Nz of the first three-dimensional shaping device is replaced within a period from a date and time when the first underlayer is shaped on the first shaping plate to a current time (step S150). Here, the processing of step S150 will be described.

In the storage device 200, nozzle-related information associated with the shaping plate use history information is stored together with the shaping plate use history information. The nozzle-related information is information related to the nozzle Nz attached to the three-dimensional shaping device 100. The nozzle-related information includes nozzle replacement history information. The nozzle-related information may include other types of information in addition to the nozzle replacement history information. The nozzle replacement history information is information indicating a replacement history of the nozzle Nz attached to the three-dimensional shaping device 100. The nozzle replacement history information is, for example, information with which nozzle replacement date and time information indicating a date and time when the nozzle Nz is replaced, nozzle identification information for identifying a new nozzle Nz attached to the three-dimensional shaping device 100 by the replacement of the nozzle Nz, and three-dimensional shaping device identification information for identifying the three-dimensional shaping device 100 to which the new nozzle Nz is attached by the replacement of the nozzle Nz are associated. The first device control unit can determine, based on the nozzle replacement history information, whether the nozzle Nz is replaced within the period from the date and time when the first underlayer is shaped on the first shaping plate to the current time. For example, the first device control unit specifies, as a first date and time, the date and time indicated by the shaping date and time information included in the record including the base material type information among the records included in the first shaping plate use history information. Based on the nozzle-related information, the first device control unit specifies, as a second date and time, a date and time indicated by the latest nozzle replacement date and time information among the nozzle replacement date and time information associated with the three-dimensional shaping device identification information for identifying the first three-dimensional shaping device. When the second date and time is nearer than the first date and time, the first device control unit determines that the nozzle Nz is replaced within the period from the date and time when the first underlayer is shaped on the first shaping plate to the current time. On the other hand, when the first date and time is nearer than the second date and time, the first device control unit determines that the nozzle Nz is not replaced within the period from the date and time when the first underlayer is shaped on the first shaping plate to the current time. The first device control unit generates the nozzle-related information every time the nozzle Nz is replaced, transmits the generated nozzle-related information to the storage device 200, and stores the transmitted nozzle-related information in the storage device 200. At this time, the first device control unit may receive, from the user, information indicating that the replacement of the nozzle Nz is performed and the nozzle identification information for identifying the new nozzle Nz attached to the three-dimensional shaping device 100 by the replacement of the nozzle Nz, or may receive the two types of information by another method.

When it is determined that the nozzle Nz of the first three-dimensional shaping device is not replaced within the period from the date and time when the first underlayer is shaped on the first shaping plate to the current time (step S150: NO), the first device control unit determines not to perform both the nozzle calibration and the stage calibration (step S160). At this time, the first device control unit acquires, from the storage unit 62 of the first three-dimensional shaping device, information indicating a history of nozzle calibration in a case where the first shaping plate is attached onto the first shaping surface and information indicating a history of stage calibration in this case, among the information stored in the storage unit 62. For this reason, the information indicating the history of nozzle calibration in this case and the information indicating the history of stage calibration in this case are stored in the storage unit 62. Further, the first device control unit stores and sets an offset for each of the height of the nozzle Nz and the height of the stage 20 of the first three-dimensional shaping device in the storage unit 62 based on the acquired two types of information. Accordingly, the first device control unit can cause a state of the first three-dimensional shaping device to coincide with a state of the first three-dimensional shaping device subjected to the nozzle calibration and the stage calibration in the past, without performing the nozzle calibration and the stage calibration. Any one type or both types of the information indicating the history of nozzle calibration in this case and the information indicating the history of stage calibration in this case may be stored in the storage device 200.

Next, the first display control unit generates an image including determination result information indicating a determination result of step S160, and outputs the determination result information by displaying the generated image on the display unit 65 of the first information processing device (step S170). For example, when the first information processing device includes a speaker, the first display control unit may output a sound indicating the determination result information from the speaker. In this case, the first display control unit is configured as an output control unit. After the processing of step S170 is performed, the first device control unit ends the processing of the flowchart illustrated in FIG. 4.

On the other hand, when it is determined that the nozzle Nz of the first three-dimensional shaping device is replaced (step S150: YES), the first device control unit determines to perform the nozzle calibration but not to perform the stage calibration (step S180). At this time, the first device control unit acquires, from the storage unit 62, the information indicating the history of stage calibration in the case where the first shaping plate is attached onto the first shaping surface, among the information stored in the storage unit 62 of the first three-dimensional shaping device. Further, the first device control unit stores and sets an offset for the height of the stage 20 in the storage unit 62 based on the acquired information. Accordingly, the first device control unit can cause the state of the first three-dimensional shaping device to coincide with the state of the first three-dimensional shaping device subjected to the stage calibration in the past, without performing the stage calibration. After the processing of step S180 is performed, the first device control unit transitions to step S170, generates an image including determination result information indicating a determination result of step S180, and outputs the determination result information by displaying the generated image on the display unit 65 of the first information processing device.

On the other hand, when it is determined that the first three-dimensional shaping device does not coincide with the three-dimensional shaping device 100 that shaped the first underlayer on the first shaping plate (step S140: NO), the first device control unit determines whether there is a use history of the first shaping plate of the first three-dimensional shaping device in the past (step S190). In FIG. 4, the processing of step S190 is indicated by “Is use history present?”. In step S190, for example, the first device control unit determines whether a record including the three-dimensional shaping device identification information for identifying the first three-dimensional shaping device is present in records including shaping date and time information indicating a date and time after shaping of the first underlayer among the records included in the first shaping plate use history information. When it is determined that the record is not present, the first device control unit determines that there is no use history of the first shaping plate in the first three-dimensional shaping device in the past. On the other hand, when it is determined that the record is present, the first device control unit determines that there is the use history of the first shaping plate in the first three-dimensional shaping device in the past.

When it is determined that there is the use history of the first shaping plate in the first three-dimensional shaping device in the past (step S190: YES), the first device control unit determines whether the nozzle Nz of the first three-dimensional shaping device is replaced within the period from the date and time when the first underlayer is shaped on the first shaping plate to the current time (step S200). The processing of step S200 is the same as the processing of step S150. Therefore, in the embodiment, a detailed description of the processing of step S200 is omitted.

When it is determined that the nozzle Nz of the first three-dimensional shaping device is not replaced within the period from the date and time when the first underlayer is shaped on the first shaping plate to the current time (step S200: NO), the first device control unit determines not to perform both the nozzle calibration and the stage calibration (step S210). The processing of step S210 is the same as the processing of step S160. Therefore, in the embodiment, a detailed description of the processing of step S210 is omitted. After the processing of step S210 is performed, the first device control unit transitions to step S170, generates an image including determination result information indicating a determination result of step S210, and outputs the determination result information by displaying the generated image on the display unit 65 of the first information processing device.

On the other hand, when it is determined that the nozzle Nz of the first three-dimensional shaping device is replaced within the period from the date and time when the first underlayer is shaped on the first shaping plate to the current time (step S200: YES), the first device control unit determines to perform the nozzle calibration but not to perform the stage calibration (step S220). The processing of step S220 is the same as the processing of step S180. Therefore, in the embodiment, a detailed description of the processing of step S220 is omitted. After the processing of step S220 is performed, the first device control unit transitions to step S170, generates an image including determination result information indicating a determination result of step S220, and outputs the determination result information by displaying the generated image on the display unit 65 of the first information processing device.

On the other hand, when it is determined that there is no use history of the first shaping plate in the first three-dimensional shaping device in the past (step S190: NO), the first device control unit determines to perform both the nozzle calibration and the stage calibration (step S230). After the processing of step S230 is performed, the first device control unit transitions to step S170, generates an image including determination result information indicating a determination result of step S230, and outputs the determination result information by displaying the generated image on the display unit 65 of the first information processing device.

As described above, the first information processing device and the first three-dimensional shaping device acquire the shaping plate identification information for identifying the first shaping plate, acquire the three-dimensional shaping device identification information for identifying the first three-dimensional shaping device, acquire the shaping plate use history information, and store the shaping plate identification information, the three-dimensional shaping device identification information, and the shaping plate use history information in the storage device 200 in association with one another. Accordingly, the first information processing device and the first three-dimensional shaping device can perform the calibration determination processing. As a result, the first information processing device and the first three-dimensional shaping device can prevent an increase in cycle time in shaping of a plurality of three-dimensional shaped objects using the shaping plate.

The first information processing device and the first three-dimensional shaping device acquire the shaping plate identification information for identifying the first shaping plate and acquire the three-dimensional shaping device identification information for identifying the first three-dimensional shaping device. The first information processing device and the first three-dimensional shaping device acquire, from the storage device 200, the first shaping plate use history information associated with the acquired shaping plate identification information. Based on the acquired first shaping plate use history information and the acquired three-dimensional shaping device identification information, the first information processing device and the first three-dimensional shaping device determine whether to perform each of the nozzle calibration and the stage calibration. Accordingly, the first information processing device and the first three-dimensional shaping device can prevent an increase in cycle time in shaping of the plurality of three-dimensional shaped objects using the shaping plate.

Processing in which Information Processing Device Causes Three-Dimensional Shaping Device to Shape Underlayer on Shaping Plate

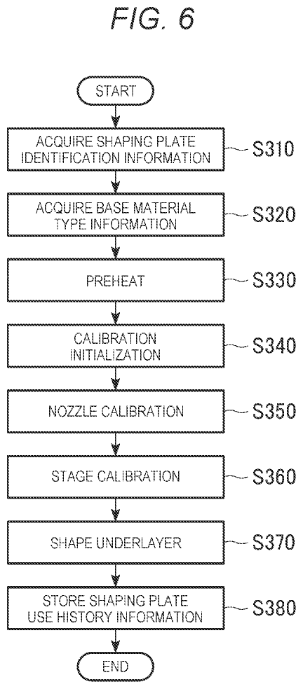

Here, processing in which the information processing device 60 causes the three-dimensional shaping device 100 to shape an underlayer on a shaping plate will be described with reference to FIG. 6. In FIG. 6, a flow of the processing in which the information processing device 60 causes the three-dimensional shaping device 100 to shape an underlayer on a shaping plate will be described by taking processing in which the first information processing device causes the first three-dimensional shaping device to shape the first underlayer on the first shaping plate as an example. FIG. 6 is a flowchart illustrating an example of a flow of the processing in which the first information processing device causes the first three-dimensional shaping device to shape the first underlayer on the first shaping plate. Hereinafter, as an example, a case will be described where, at a timing before processing of step S310 illustrated in FIG. 6 is performed, the first information processing device receives an underlayer shaping processing start operation for causing the first information processing device to start the processing. Hereinafter, a case where, at the timing, the first information processing device receives the base material type information indicating the type of the shaping material X1 for the first underlayer to be shaped on the first shaping plate and the base material type information is stored in the storage unit 62 of the first information processing device will be described. Hereinafter, as an example, a case where the first shaping plate is attached onto the first shaping surface at the timing will be described.

After receiving the underlayer shaping processing start operation, the detection unit CM of the first three-dimensional shaping device detects the shaping plate identification information of the first shaping plate attached onto the first shaping surface, and outputs the detected shaping plate identification information to the first information processing device. Accordingly, in this case, the first acquisition unit acquires, from the detection unit CM, the shaping plate identification information for identifying the first shaping plate attached onto the first shaping surface (step S310).

Next, the first device control unit reads and acquires the base material type information stored in advance in the storage unit 62 from the storage unit 62 (step S320).

Next, the first device control unit controls the heating unit 40 to heat the shaping region until a temperature of the shaping region reaches a predetermined temperature (step S330). In FIG. 6, the processing of step S330 is indicated by “preheat”.

Next, the first device control unit performs calibration initialization (step S340). Here, the processing of step S340 will be described.

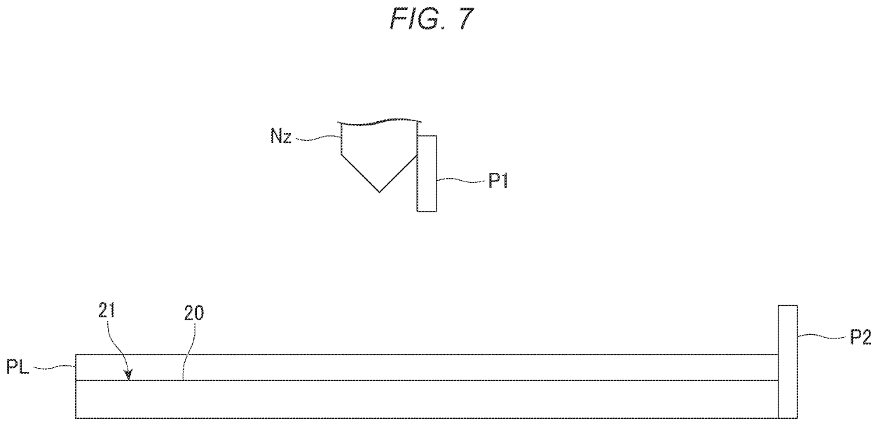

The calibration initialization is processing of relatively moving the nozzle Nz and the stage 20 to respective reference positions for the position of the nozzle Nz in the XY plane, the height of the nozzle Nz, and the height of the stage 20 in order to perform the nozzle calibration and the stage calibration. The reference position is predetermined in the first three-dimensional shaping device. For this reason, reference position information indicating the reference position is stored in advance in the storage unit 62 of the first information processing device. FIG. 7 is a diagram illustrating an example of a relative positional relationship between the nozzle Nz of the first three-dimensional shaping device and the stage 20 of the first three-dimensional shaping device when viewed along a direction orthogonal to the gravity direction at a timing before start of the calibration initialization. A shaping plate PL illustrated in FIG. 7 is an example of the first shaping plate. In the example illustrated in FIG. 7, the nozzle Nz is provided with a calibration pin P1 used for the stage calibration. The calibration pin P1 is a pin that moves together with the nozzle Nz. In FIG. 7, in order to simplify the drawing, the calibration pin P1 is illustrated as being provided at the nozzle Nz. However, the calibration pin P1 may be provided at a member different from the nozzle Nz as long as the calibration pin P1 is movable together with the nozzle Nz. The calibration pin P1 is provided at the member such that a lower end of the calibration pin P1 is positioned on a lower side of the tip end of the nozzle Nz. The calibration pin P1 may be provided to be able to be accommodated in the member, at which the calibration pin P1 is provided, when the calibration pin P1 is not used. In this example, the stage 20 is provided with a calibration pin P2 used for the nozzle calibration. In FIG. 7, the calibration pin P2 is provided at an end of the stage 20 in the horizontal direction. However, the calibration pin P2 may be provided at another position as long as the calibration pin P2 does not interfere with the shaping of the three-dimensional shaped object. An upper end of the calibration pin P2 is provided at the stage 20 so as to be positioned higher than the first shaping surface. The calibration pin P2 is provided at the stage 20 such that the position of the upper end of the calibration pin P2 coincides with the reference position. In the storage unit 62, first relative position information indicating a relative position of the lower end of the calibration pin P1 with respect to the tip end of the nozzle Nz is stored in advance.

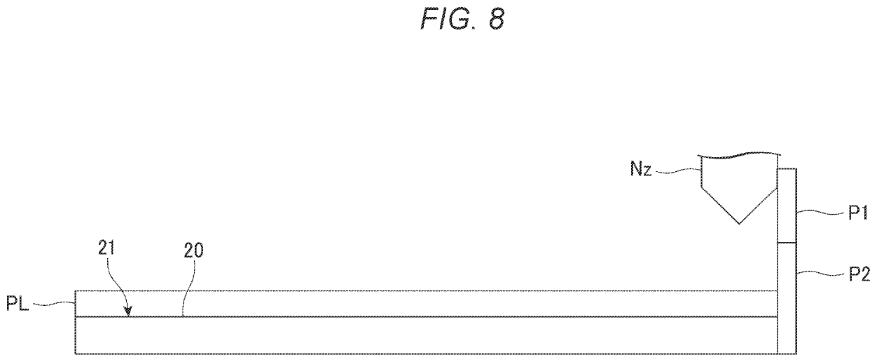

FIG. 8 is a diagram illustrating an example of a relative positional relationship between the nozzle Nz of the first three-dimensional shaping device and the stage 20 of the first three-dimensional shaping device immediately after execution of the calibration initialization. The first device control unit controls the moving part 30 based on the reference position information and the first relative position information stored in advance in the storage unit 62, moves the position of the lower end of the calibration pin P1 to the position of the upper end of the calibration pin P2, and brings the lower end of the calibration pin P1 and the upper end of the calibration pin P2 into contact with each other as illustrated in FIG. 8. Accordingly, the first information processing device completes the calibration initialization as a preparation for performing each of the nozzle calibration and the stage calibration. That is, the nozzle calibration is processing of storing an offset between the position of the tip end of the nozzle Nz in a state where the lower end of the calibration pin P1 is in contact with the upper end of the calibration pin P2 and the position of the tip end of the nozzle Nz in a state where the tip end of the nozzle Nz is in contact with the calibration pin P2. The stage calibration is processing of storing an offset between the position of the tip end of the nozzle Nz in the state where the lower end of the calibration pin P1 is in contact with the upper end of the calibration pin P2 and the position of the tip end of the nozzle Nz in a state where the tip end of the nozzle Nz is in contact with an upper surface of the shaping plate PL. After bringing the lower end of the calibration pin P1 into contact with the upper end of the calibration pin P2, the first device control unit stores information, which indicates the position of the tip end of the nozzle Nz in the state where the lower end of the calibration pin P1 is in contact with the upper end of the calibration pin P2, as initialization position information in the storage unit 62 of the first information processing device.

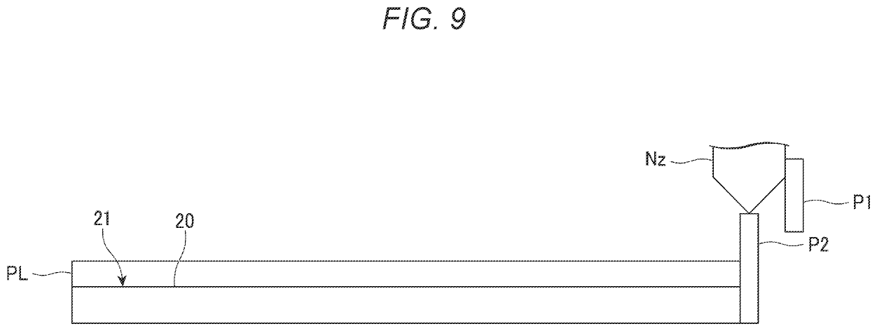

After the calibration initialization is performed in step S340, the first device control unit performs the nozzle calibration (step S350). Specifically, the first device control unit controls the moving part 30 to move the position of the tip end of the nozzle Nz to the position of the upper end of the calibration pin P2, thereby bringing the tip end of the nozzle Nz into contact with the upper end of the calibration pin P2 as illustrated in FIG. 9. FIG. 9 is a diagram illustrating an example of the relative positional relationship between the nozzle Nz of the first three-dimensional shaping device and the stage 20 of the first three-dimensional shaping device immediately after execution of the nozzle calibration. After bringing the tip end of the nozzle Nz into contact with the upper end of the calibration pin P2, the first device control unit stores information, which indicates the position of the tip end of the nozzle Nz in a state where the tip end of the nozzle Nz is in contact with the upper end of the calibration pin P2, in the storage unit 62 of the first information processing device as information indicating a history of nozzle calibration. After bringing the tip end of the nozzle Nz into contact with the upper end of the calibration pin P2, the first device control unit stores and sets, in the storage unit 62, an offset between the position indicated by the initialization position information stored in the storage unit 62 and the position of the tip end of the nozzle Nz in the state where the tip end of the nozzle Nz is in contact with the upper end of the calibration pin P2. Accordingly, the first device control unit completes the nozzle calibration.

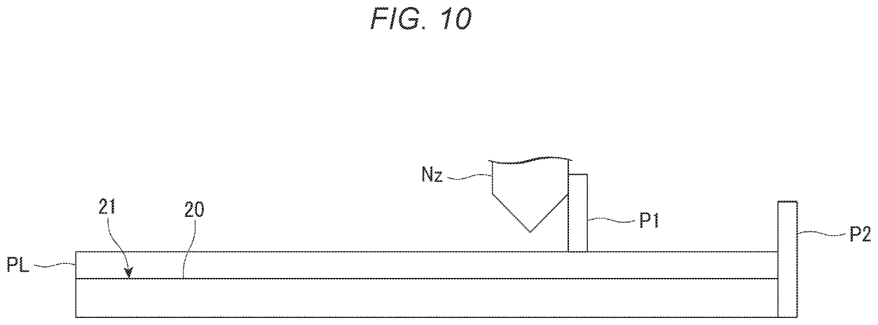

After the nozzle calibration is performed in step S350, the first device control unit performs the stage calibration (step S360). Specifically, the first device control unit controls the moving part 30 to bring the lower end of the calibration pin P1 into contact with the upper surface of the shaping plate PL. FIG. 10 is a diagram illustrating an example of the relative positional relationship between the nozzle Nz of the first three-dimensional shaping device and the stage 20 of the first three-dimensional shaping device immediately after execution of the stage calibration. After bringing the lower end of the calibration pin P1 into contact with the upper surface of the shaping plate PL, the first device control unit stores information, which indicates the position of the tip end of the nozzle Nz in a state where the lower end of the calibration pin P1 is in contact with the upper surface of the shaping plate PL, in the storage unit 62 of the first information processing device as information indicating a history of stage calibration. After bringing the lower end of the calibration pin P1 into contact with the upper surface of the shaping plate PL, the first device control unit stores and sets, in the storage unit 62, an offset between the position indicated by the initialization position information stored in the storage unit 62 and the position of the tip end of the nozzle Nz in the state where the lower end of the calibration pin P1 is in contact with the upper surface of the shaping plate PL. Accordingly, the first device control unit completes the stage calibration.

Next, the first device control unit controls each of the discharge part 10 and the moving part 30 to cause the first three-dimensional shaping device to shape the first underlayer on the first shaping plate (step S370).

Next, the first device control unit specifies the shaping plate identification information acquired by the first acquisition unit in step S310, the shaping date and time information, the base material type information, the job identification information, the thermal history information, the set value information, the three-dimensional shaping device identification information, and the like. Then, based on the specified information, the first device control unit adds a record, which includes the shaping date and time information, the base material type information, the job identification information, the thermal history information, the set value information, the three-dimensional shaping device identification information, and the like, and which is associated with the shaping plate identification information, to the shaping plate use history information stored in the storage device 200 (step S380). In FIG. 6, the processing of step S380 is indicated by “store shaping plate use history information”. After the processing of step S380 is performed, the first device control unit ends the processing of the flowchart illustrated in FIG. 6.

Through the above-described processing, the first three-dimensional shaping device can shape the first underlayer on the first shaping plate. At a timing after the processing of step S360 is performed, the first device control unit stores the nozzle calibration position information, which is stored in the storage unit 62 by the first device control unit, as information indicating a history of nozzle calibration in the storage unit 62 or the storage device 200 in association with the shaping plate identification information acquired by the first acquisition unit in step S310. At a timing after the processing of step S360 is performed, the first device control unit stores the stage calibration position information, which is stored in the storage unit 62 by the first device control unit, as information indicating a history of stage calibration in the storage unit 62 or the storage device 200 in association with the shaping plate identification information acquired by the first acquisition unit in step S310. Here, the position indicated by the nozzle calibration position information is the position of the tip end of the nozzle Nz in the state where the tip end of the nozzle Nz is in contact with the upper end of the calibration pin P2. The position indicated by the stage calibration position information is the position of the tip end of the nozzle Nz in the state where the lower end of the calibration pin P1 is in contact with the upper surface of the shaping plate PL.

Here, the calibration determination processing in the flowchart illustrated in FIG. 4 is processing executed when the first shaping plate on which the first underlayer is shaped by the processing in the flowchart illustrated in FIG. 6 is attached to the first three-dimensional shaping device. When it is determined in step S230 illustrated in FIG. 4 that the nozzle calibration and the stage calibration are to be performed, the first information processing device performs the processing of steps S340 to S360 illustrated in FIG. 6 to perform the nozzle calibration and the stage calibration, before causing the first three-dimensional shaping device to shape the three-dimensional shaped object above the first underlayer on the first shaping plate. When it is determined in step S180 or step S220 that the nozzle calibration is to be performed but the stage calibration is not to be performed, the first information processing device performs the processing of steps S340 and S350 to perform the nozzle calibration without performing the stage calibration, before causing the first three-dimensional shaping device to shape the three-dimensional shaped object above the first underlayer on the first shaping plate. When it is determined in step S160 that the nozzle calibration and the stage calibration are not to be performed, the first information processing device omits the nozzle calibration and the stage calibration before causing the first three-dimensional shaping device to shape the three-dimensional shaped object above the first underlayer on the first shaping plate. Accordingly, based on the use history of the first shaping plate on which the first underlayer is shaped, the first information processing device can prevent an increase in cycle time in shaping of the plurality of three-dimensional shaped objects using the first shaping plate.

The contents described above may be combined in any manner.

### APPENDIX

[1] An information processing system includes: one or more information processing devices configured to control one or more three-dimensional shaping devices configured to shape a three-dimensional shaped object; a first acquisition unit configured to acquire first shaping plate identification information for identifying a first shaping plate, the first shaping plate having an upper surface on which the three-dimensional shaped object is to be shaped and being attachable to a stage of a first three-dimensional shaping device among the one or more three-dimensional shaping devices; a second acquisition unit configured to acquire first three-dimensional shaping device identification information for identifying the first three-dimensional shaping device; a third acquisition unit configured to acquire first-underlayer-related information related to a first underlayer to be shaped on the upper surface of the first shaping plate; and a control unit. The control unit stores, in a storage device, the first shaping plate identification information, the first three-dimensional shaping device identification information, and the first-underlayer-related information in association with one another.

[2] In the information processing system according to [1], the first-underlayer-related information includes first underlayer number-of-use information indicating the number of uses of the first underlayer, and the control unit determines whether the number of uses of the first underlayer exceeds a predetermined first threshold, based on the first-underlayer-related information acquired by the third acquisition unit.

[3] In the information processing system according to [1] or [2], the first-underlayer-related information includes first underlayer elapsed time information indicating an elapsed time from shaping of the first underlayer, and the control unit determines whether the elapsed time from shaping of the first underlayer exceeds a predetermined second threshold, based on the first-underlayer-related information acquired by the third acquisition unit.

[4] In the information processing system according to any one of [1] to [3], the first-underlayer-related information includes first underlayer thermal history information indicating a thermal history of the first underlayer, the first underlayer thermal history information includes first thermal history integrated value information indicating an integrated value of the thermal history of the first underlayer, and the control unit determines whether the integrated value of the thermal history of the first underlayer exceeds a predetermined third threshold, based on the first-underlayer-related information acquired by the third acquisition unit.

[5] In the information processing system according to any one of [2] to [4], the control unit causes an output unit to output information corresponding to a determination result.

[6] An information processing system includes: one or more information processing devices configured to control one or more three-dimensional shaping devices configured to shape a three-dimensional shaped object; a first acquisition unit configured to acquire first shaping plate identification information for identifying a first shaping plate, the first shaping plate having an upper surface on which the three-dimensional shaped object is to be shaped and being attachable to a stage of a first three-dimensional shaping device among the one or more three-dimensional shaping devices; a second acquisition unit configured to acquire first three-dimensional shaping device identification information for identifying the first three-dimensional shaping device; and a control unit. The control unit acquires, from a storage device that stores the first shaping plate identification information and first-underlayer-related information related to a first underlayer to be shaped on the upper surface of the first shaping plate in association with each other, the first-underlayer-related information associated with the first shaping plate identification information acquired by the first acquisition unit, and determines whether to perform a calibration for each of a height of a nozzle from which the first three-dimensional shaping device discharges a shaping material and a height of the stage of the first three-dimensional shaping device, based on the acquired first-underlayer-related information and the first three-dimensional shaping device identification information acquired by the second acquisition unit.

[7] In the information processing system according to [6], the control unit outputs information indicating a determination result.

[8] In the information processing system according to [6] or [7], the first shaping plate identification information acquired by the first acquisition unit is information detected from any one of a two-dimensional code, a radio frequency identification (RFID) tag, and an integrated circuit (IC) tag.

[9] A storage device provided in an information processing system including one or more information processing devices configured to control one or more three-dimensional shaping devices configured to shape a three-dimensional shaped object stores first shaping plate identification information for identifying a first shaping plate and first-underlayer-related information in associated with each other, the first shaping plate having an upper surface on which the three-dimensional shaped object is to be shaped and being attachable to a stage of a first three-dimensional shaping device among the one or more three-dimensional shaping devices, and the first-underlayer-related information being related to a first underlayer to be shaped on the upper surface of the first shaping plate. The first-underlayer-related information includes three-dimensional shaping device identification information for identifying the three-dimensional shaping device that has shaped the first underlayer among the one or more three-dimensional shaping devices.

[10] In the storage device according to [9], the first-underlayer-related information includes first underlayer number-of-use information indicating the number of uses of the first underlayer.

[11] In the storage device according to [9] or [10], the first-underlayer-related information includes first underlayer shaping date and time information indicating a date and time when the first underlayer is shaped.

[12] In the storage device according to any one of [9] to [11], the first-underlayer-related information includes first underlayer thermal history information indicating a thermal history of the first underlayer.

[13] In the storage device according to [12], the first underlayer thermal history information includes any one or both of underlayer heating time information indicating a heating time in which the first underlayer is heated and underlayer heating temperature information indicating a heating temperature at which the first underlayer is heated.

[14] In the storage device according to any one of [9] to [13], the first-underlayer-related information and first-nozzle-related information related to a nozzle of the first three-dimensional shaping device are stored in association with each other, and the first-nozzle-related information includes nozzle identification information for identifying a nozzle attached to the three-dimensional shaping device that has shaped the first underlayer.

[15] In the storage device according to [14], the first-nozzle-related information includes information indicating a replacement history of the nozzle attached to the three-dimensional shaping device that has shaped the first underlayer.

[16] A three-dimensional shaping device includes: a stage; a discharge head configured to discharge a shaping material on a shaping plate attached to the stage; a detection unit configured to detect shaping plate identification information of the shaping plate when the shaping plate is attached to the stage; a moving part configured to move the stage and the discharge head relative to each other; and a control unit. The shaping plate identification information is information for identifying the shaping plate. The control unit acquires, from a storage device that stores the shaping plate identification information and underlayer-related information related to an underlayer to be shaped on an upper surface of the shaping plate in association with each other, the underlayer-related information associated with the shaping plate identification information detected by the detection unit, and determines whether to perform a calibration for each of a height of a nozzle of the discharge head and a height of the stage, based on the acquired underlayer-related information.

[17] In the three-dimensional shaping device according to [16], the underlayer-related information includes three-dimensional shaping device identification information for identifying a three-dimensional shaping device that has shaped the underlayer indicated by the underlayer-related information, and the control unit determines whether to perform the calibration, based on three-dimensional shaping device identification information for identifying an own three-dimensional shaping device and three-dimensional shaping device identification information for identifying the three-dimensional shaping device that has shaped the underlayer indicated by the underlayer-related information.

[18] In the three-dimensional shaping device according to or [17], a storage unit is provided, and the control unit causes the storage unit or the storage device to store the shaping plate identification information and calibration history information indicating a history of calibration in association with each other.

[19] In the three-dimensional shaping device according to any one of to [18], the shaping plate identification information of the shaping plate is information of any one of information encoded as a two-dimensional code, information stored in a radio frequency identification (RFID) tag, or information stored in an integrated circuit (IC) tag.

[20] An information processing system includes: one or more information processing devices configured to control one or more three-dimensional shaping devices configured to shape a three-dimensional shaped object. The information processing system determines, according to a use history of a first shaping plate, whether to perform a calibration for each of a height of a nozzle from which a first three-dimensional shaping device discharges a shaping material and a height of a stage of the first three-dimensional shaping device, the first shaping plate having an upper surface on which the three-dimensional shaped object is to be shaped and being attachable to the stage of the first three-dimensional shaping device among the one or more three-dimensional shaping devices.

Although the embodiment of the present disclosure has been described in detail with reference to the drawings, a specific configuration thereof is not limited to the embodiment, and modification, replacement, deletion, or the like may be made without departing from the gist of the present disclosure.

In addition, a program for implementing the function of any component in the device described above may be stored in a computer-readable storage medium, and the program may be read and executed by a computer system. Here, the device is, for example, the information processing device 60, the data generation device 70, the three-dimensional shaping device 100, the storage device 200, or the like. Here, the term “computer system” includes an operating system (OS) and hardware such as peripheral devices. The term “computer-readable storage medium” refers to a storage device such as a portable medium such as a flexible disk, a magneto-optical disk, an ROM, or a compact disc (CD)-ROM, or a hard disk built in the computer system. Further, the “computer-readable storage medium” includes a medium that holds a program for a certain period of time, such as a volatile memory inside a computer system serving as a server or a client in a case where the program is transmitted via a network such as the Internet or a communication line such as a telephone line.

The program may be transmitted from a computer system, in which the program is stored in a storage device or the like, to another computer system via a transmission medium or through a transmission wave in a transmission medium. Here, the “transmission medium” that transmits a program refers to a medium having a function of transmitting information, like a network such as the Internet or a communication line such as a telephone line.

The program may be a program for implementing a part of the above-described functions. Further, the program may be a so-called differential file or differential program that can implement the above-described functions in combination with a program already stored in the computer system.

What is claimed is:

1. An information processing system comprising:
one or more information processing devices configured to control one or more three-dimensional shaping devices configured to shape a three-dimensional shaped object;
a first acquisition unit configured to acquire first shaping plate identification information for identifying a first shaping plate, the first shaping plate having an upper surface on which the three-dimensional shaped object is to be shaped and being attachable to a stage of a first three-dimensional shaping device among the one or more three-dimensional shaping devices;
a second acquisition unit configured to acquire first three-dimensional shaping device identification information for identifying the first three-dimensional shaping device;
a third acquisition unit configured to acquire first-underlayer-related information related to a first underlayer to be shaped on the upper surface of the first shaping plate; and
a control unit, wherein
the control unit stores, in a storage device, the first shaping plate identification information, the first three-dimensional shaping device identification information, and the first-underlayer-related information in association with one another.

2. The information processing system according to claim 1, wherein
the first-underlayer-related information includes first underlayer number-of-use information indicating the number of uses of the first underlayer, and
the control unit determines whether the number of uses of the first underlayer exceeds a predetermined first threshold, based on the first-underlayer-related information acquired by the third acquisition unit.

3. The information processing system according to claim 1, wherein
the first-underlayer-related information includes first underlayer elapsed time information indicating an elapsed time from shaping of the first underlayer, and
the control unit determines whether the elapsed time from shaping of the first underlayer exceeds a predetermined second threshold, based on the first-underlayer-related information acquired by the third acquisition unit.

4. The information processing system according to claim 1, wherein
the first-underlayer-related information includes first underlayer thermal history information indicating a thermal history of the first underlayer,
the first underlayer thermal history information includes first thermal history integrated value information indicating an integrated value of the thermal history of the first underlayer, and
the control unit determines whether the integrated value of the thermal history of the first underlayer exceeds a predetermined third threshold, based on the first-underlayer-related information acquired by the third acquisition unit.

5. The information processing system according to claim 2, wherein
the control unit causes an output unit to output information corresponding to a determination result.

6. An information processing system comprising:
one or more information processing devices configured to control one or more three-dimensional shaping devices configured to shape a three-dimensional shaped object;
a first acquisition unit configured to acquire first shaping plate identification information for identifying a first shaping plate, the first shaping plate having an upper surface on which the three-dimensional shaped object is to be shaped and being attachable to a stage of a first three-dimensional shaping device among the one or more three-dimensional shaping devices;
a second acquisition unit configured to acquire first three-dimensional shaping device identification information for identifying the first three-dimensional shaping device; and
a control unit, wherein
the control unit acquires, from a storage device that stores the first shaping plate identification information and first-underlayer-related information related to a first underlayer to be shaped on the upper surface of the first shaping plate in association with each other, the first-underlayer-related information associated with the first shaping plate identification information acquired by the first acquisition unit, and determines whether to perform a calibration for each of a height of a nozzle from which the first three-dimensional shaping device discharges a shaping material and a height of the stage of the first three-dimensional shaping device, based on the acquired first-underlayer-related information and the first three-dimensional shaping device identification information acquired by the second acquisition unit.

7. The information processing system according to claim 6, wherein
the control unit outputs information indicating a determination result.

8. The information processing system according to claim 6, wherein
the first shaping plate identification information acquired by the first acquisition unit is information detected from any one of a two-dimensional code, a radio frequency identification (RFID) tag, and an integrated circuit (IC) tag.

9. A storage device provided in an information processing system including one or more information processing devices that control one or more three-dimensional shaping devices configured to shape a three-dimensional shaped object, wherein
the storage device stores first shaping plate identification information for identifying a first shaping plate and first-underlayer-related information in associated with each other, the first shaping plate having an upper surface on which the three-dimensional shaped object is to be shaped and being attachable to a stage of a first three-dimensional shaping device among the one or more three-dimensional shaping devices, and the first-underlayer-related information being related to a first underlayer to be shaped on the upper surface of the first shaping plate, and
the first-underlayer-related information includes three-dimensional shaping device identification information for identifying the three-dimensional shaping device that has shaped the first underlayer among the one or more three-dimensional shaping devices.

10. The storage device according to claim 9, wherein
the first-underlayer-related information includes first underlayer number-of-use information indicating the number of uses of the first underlayer.

11. The storage device according to claim 9, wherein
the first-underlayer-related information includes first underlayer shaping date and time information indicating a date and time when the first underlayer is shaped.

12. The storage device according to claim 9, wherein
the first-underlayer-related information includes first underlayer thermal history information indicating a thermal history of the first underlayer.

13. The storage device according to claim 12, wherein
the first underlayer thermal history information includes any one of or both of underlayer heating time information indicating a heating time in which the first underlayer is heated and underlayer heating temperature information indicating a heating temperature at which the first underlayer is heated.

14. The storage device according to claim 9, wherein
the first-underlayer-related information and first-nozzle-related information related to a nozzle of the first three-dimensional shaping device are stored in association with each other, and
the first-nozzle-related information includes nozzle identification information for identifying a nozzle attached to the three-dimensional shaping device that has shaped the first underlayer.

15. The storage device according to claim 14, wherein
the first-nozzle-related information includes information indicating a replacement history of the nozzle attached to the three-dimensional shaping device that has shaped the first underlayer.

16. A three-dimensional shaping device, comprising:
a stage;
a discharge head configured to discharge a shaping material on a shaping plate attached to the stage;
a detection unit configured to detect shaping plate identification information of the shaping plate when the shaping plate is attached to the stage;
a moving part configured to move the stage and the discharge head relative to each other; and
a control unit, wherein
the shaping plate identification information is information for identifying the shaping plate, and
the control unit acquires, from a storage device that stores the shaping plate identification information and underlayer-related information related to an underlayer to be shaped on an upper surface of the shaping plate in association with each other, the underlayer-related information associated with the shaping plate identification information detected by the detection unit, and determines whether to perform a calibration for each of a height of a nozzle of the discharge head and a height of the stage, based on the acquired underlayer-related information.

17. The three-dimensional shaping device according to claim 16, wherein
the underlayer-related information includes three-dimensional shaping device identification information for identifying a three-dimensional shaping device that has shaped the underlayer indicated by the underlayer-related information, and
the control unit determines whether to perform the calibration, based on three-dimensional shaping device identification information for identifying an own three-dimensional shaping device and three-dimensional shaping device identification information for identifying the three-dimensional shaping device that has shaped the underlayer indicated by the underlayer-related information.

18. The three-dimensional shaping device according to claim 16, further comprising:
a storage unit, wherein
the control unit causes the storage unit or the storage device to store the shaping plate identification information and calibration history information indicating a history of calibration in association with each other.

19. The three-dimensional shaping device according to claim 16, wherein
the shaping plate identification information of the shaping plate is information of any one of information encoded as a two-dimensional code, information stored in a radio frequency identification (RFID) tag, or information stored in an integrated circuit (IC) tag.

20. An information processing system comprising:
one or more information processing devices configured to control one or more three-dimensional shaping devices configured to shape a three-dimensional shaped object, wherein
the information processing system determines, according to a use history of a first shaping plate, whether to perform a calibration for each of a height of a nozzle from which a first three-dimensional shaping device discharges a shaping material and a height of a stage of the first three-dimensional shaping device, the first shaping plate having an upper surface on which the three-dimensional shaped object is to be shaped and being attachable to the stage of the first three-dimensional shaping device among the one or more three-dimensional shaping devices.
